(19) United States
(12) Patent Application Publication
(10) Pub. No.: US 2004/0223884 A1
(43) Pub. Date: Nov. 11, 2004

(54) Chemical sensor responsive to change in volume of material exposed to target particle

(76) Inventors: Ing-Shin Chen, Danbury, CT (US); Frank DiMeo JR., Danbury, CT (US)

Correspondence Address: Oliver A. Zitzmann, ATMI, Inc., 7 Commerce Drive, Danbury, CT, 06810, US

(21) Appl. No.: 10/429,909

(22) Filed: May 5, 2003

(51) Int. Cl. G01N 30/96

(52) U.S. Cl. 422/88

(57) ABSTRACT

A sensor comprises sensing material that changes volume when exposed to one or more target particles. The sensor also comprises a transducing platform comprising a piezoresistive component to sense change in volume of the sensing material. The sensing material is positioned over the piezoresistive component.

### GOVERNMENT RIGHTS

One or more embodiments described in this patent application were conceived with U.S. Government support under Contract No. DE-FC36-99GO10451. The U.S. Government has certain rights in this patent application.

### TECHNICAL FIELD

One or more embodiments described in this patent application relate to the field of chemical sensors.

### BACKGROUND ART

Chemical sensors may be used for a wide variety of purposes. Hydrogen (H₂) sensors, for example, may be used to help detect hydrogen gas leaks and to help monitor and control hydrogen-based processes for fuel cells, for example. Carbon monoxide (CO) sensors may be used to help detect unsafe levels of carbon monoxide in a home or garage, for example. Propane sensors may be used in conjunction with gas grills. Industrial sensors may be used to help detect unsafe levels of chemicals or toxins at chemical plants, coal mines, or semiconductor fabrication facilities, for example.

### SUMMARY

One or more embodiments of a sensor comprise sensing material that changes volume when exposed to one or more target particles and comprise a transducing platform comprising a piezoresistive component to sense change in volume of the sensing material. The sensing material is positioned over the piezoresistive component.

One or more embodiments of another sensor comprise a first layer comprising a piezoresistive material to sense change in volume of one or more layers over the first layer and comprise a second layer over the first layer. The second layer comprises a material that changes volume when exposed to one or more target particles.

One or more embodiments of an apparatus comprise sensing material that changes volume when exposed to one or more target particles, means for sensing change in volume of the sensing material, and means for controlling temperature of the sensing material.

One or more embodiments of a sensing device comprise a sensor and a controller. The sensor comprises a piezoresistive layer and sensing material over the piezoresistive layer. The sensing material changes volume when exposed to one or more target particles. The controller is to sense a resistance of the piezoresistive layer.

One or more embodiments of a method comprise forming over a substrate a first layer comprising a piezoresistive material to sense change in volume of one or more layers over the first layer and comprise forming over the first layer a second layer comprising a material that changes volume when exposed to a target particle.

One or more embodiments of another method comprise sensing a resistance of a piezoresistive layer with sensing material over the piezoresistive layer. The sensing material changes volume when exposed to one or more target particles. The one or more embodiments also comprise identifying whether a target particle is near the sensing material based on the sensed resistance of the piezoresistive layer.

One or more embodiments of another sensing device comprise an array of sensors and a controller. At least one sensor comprises a piezoresistive layer and sensing material over the piezoresistive layer. The sensing material changes volume when exposed to one or more target particles. The controller is coupled to the array of sensors to sense a resistance of the piezoresistive layer of at least one sensor.

### BRIEF DESCRIPTION OF THE DRAWINGS

One or more embodiments are illustrated by way of example and not limitation in the figures of the accompanying drawings, in which like references indicate similar elements and in which:

FIG. 1 illustrates, for one embodiment, a block diagram of a sensing device comprising a chemical sensor responsive to change in volume of material exposed to a target particle;

FIG. 2 illustrates, for one embodiment, a flow diagram to form a sensing device comprising a chemical sensor responsive to change in volume of material exposed to a target particle;

FIG. 3 illustrates, for one embodiment, a flow diagram to use a chemical sensor responsive to change in volume of material exposed to a target particle;

FIG. 4 illustrates a flow diagram summarizing embodiments of techniques to form a piezoresistive chemical sensor;

FIG. 5 illustrates, for one embodiment, a plan view of a microhotplate structure for a piezoresistive chemical sensor;

FIG. 6 illustrates, for one embodiment, a plan view of a piezoresistive chemical sensor having a microhotplate structure;

FIG. 7 illustrates, for one embodiment, a cross-sectional view of the piezoresistive chemical sensor of FIG. 6;

FIG. 8 illustrates, for one embodiment, a block diagram of a sensing device comprising a piezoresistive chemical sensor;

FIG. 9 illustrates, for one embodiment, a flow diagram to use a piezoresistive chemical sensor to sense a target particle;

FIG. 10 illustrates, for one embodiment, a plan view of a microhotplate structure having a heat distribution layer for a piezoresistive chemical sensor;

FIG. 11 illustrates, for one embodiment, a cross-sectional view of a piezoresistive chemical sensor having a heat distribution layer;

FIG. 12 illustrates, for one embodiment, a plan view of a microhotplate structure having a contact layer for a piezoresistive chemical sensor;

FIG. 13 illustrates, for one embodiment, a cross-sectional view of a piezoresistive chemical sensor having a contact layer;

FIG. 14 illustrates, for one embodiment, a block diagram of a sensing device comprising a piezoresistive chemical sensor having a contact layer;

FIG. 15 illustrates, for one embodiment, a flow diagram to use a piezoresistive chemical sensor having a contact layer to sense a target particle;

FIG. 16 illustrates, for one embodiment, a plan view of a microcantilever structure for a piezoresistive chemical sensor;

FIG. 17 illustrates, for one embodiment, a plan view of a diaphragm structure for a piezoresistive chemical sensor;

FIG. 18 illustrates, for one embodiment, a cross-sectional view of a piezoresistive chemical sensor having a diaphragm structure;

FIG. 19 illustrates a flow diagram summarizing embodiments of techniques to form a piezoresistive chemical sensor having a piezoresistive layer separate from a heater layer;

FIG. 20 illustrates, for one embodiment, a plan view of a microhotplate structure having a piezoresistive layer separate from a heater layer for a piezoresistive chemical sensor;

FIG. 21 illustrates, for one embodiment, a cross-sectional view of a piezoresistive chemical sensor having a piezoresistive layer separate from a heater layer;

FIG. 22 illustrates, for another embodiment, a plan view of a microhotplate structure having a piezoresistive layer separate from a heater layer for a piezoresistive chemical sensor;

FIG. 23 illustrates, for another embodiment, a cross-sectional view of a piezoresistive chemical sensor having a piezoresistive layer separate from a heater layer;

FIG. 24 illustrates, for one embodiment, a block diagram of a sensing device comprising a piezoresistive chemical sensor having a piezoresistive layer separate from a heater layer;

FIG. 25 illustrates, for one embodiment, a flow diagram to use a piezoresistive chemical sensor having a piezoresistive layer separate from a heater layer to sense a target particle; and

FIG. 26 illustrates, for one embodiment, a block diagram of a sensing device comprising an array of chemical sensors at least one of which is responsive to change in volume of material exposed to a target particle.

### DETAILED DESCRIPTION

The following detailed description sets forth an embodiment or embodiments for a chemical sensor responsive to change in volume of material exposed to a target particle.

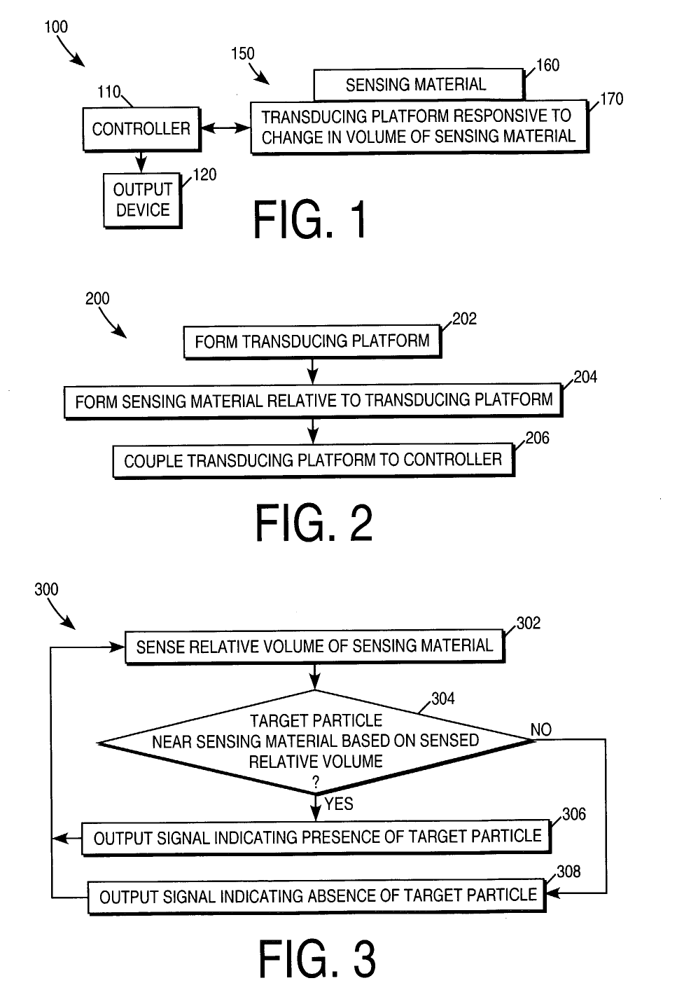

FIG. 1 illustrates, for one embodiment, a sensing device 100. Sensing device 100 may be used to sense any suitable target particle in any suitable environment for any suitable purpose. Sensing device 100 comprises a controller 110 and a chemical sensor 150 coupled to controller 110.

Sensor 150 comprises sensing material 160 that changes volume when exposed to one or more target particles. Sensor 150 also comprises a transducing platform 170 responsive to change in volume of sensing material 160. Sensor 150 for one embodiment is integrated.

Controller 110 may be coupled to transducing platform 170 to sense the presence of a target particle in an environment near sensing material 160. Controller 110 for one embodiment may also be coupled to or in wireless communication with an output device 120 to output to output device 120 a signal indicating the presence of a target particle near sensing material 160. Output device 120 may or may not be a component of sensing device 100. At least a portion of controller 110 and/or output device 120 may be local to or remote from sensor 150. Output device 120 may be local to or remote from controller 110.

FIG. 2 illustrates, for one embodiment, a flow diagram 200 to form sensing device 100.

For block 202 of FIG. 2, transducing platform 170 is formed. Transducing platform 170 may be formed to sense change in volume of sensing material 160 in any suitable manner. Transducing platform 170 for one embodiment may comprise a piezoresistive component to sense change in volume of sensing material 160 through change in resistance of the piezoresistive component due to the placement of strain on and/or the release of strain from the piezoresistive component by sensing material 160. Transducing platform 170 for one embodiment may comprise a structure of suitable elasticity to help support the piezoresistive component and to yield to placement of strain on the piezoresistive component, helping to enhance sensitivity of the piezoresistive component to change in volume of sensing material 160. Transducing platform 170 for one embodiment may comprise a heater component to help control temperature of sensing material 160 to help control sensitivity of sensing material 160 to one or more target particles and/or to help control selectivity of sensing material 160 to one or more target particles in the presence of one or more non-target particles.

Transducing platform 170 for one embodiment may comprise a microelectromechanical system (MEMS) device or micromachine. Transducing platform 170 for one embodiment may comprise any suitable microhotplate structure. Transducing platform 170 for one embodiment may comprise any suitable microcantilever structure. Transducing platform 170 for one embodiment may comprise any suitable diaphragm structure. Transducing platform 170 may be formed in any suitable manner using any suitable techniques, including metal oxide semiconductor (MOS) processing techniques for example.

For block 204, sensing material 160 is formed relative to transducing platform 170 to allow transducing platform 170 to sense change in volume of sensing material 160. Sensing material 160 for one embodiment may be formed directly or indirectly over transducing platform 170. Sensing material 160 for one embodiment may be formed directly or indirectly over a piezoresistive component of transducing platform 170. Sensing material 160 may be formed in any suitable manner to comprise any suitable material that changes volume when exposed to any suitable one or more target particles. Sensing material 160 for one embodiment may be formed to comprise any suitable material that expands when exposed to any suitable one or more target particles. Such expansion of sensing material 160 may or may not be reversible. Sensing material 160 for one embodiment may be formed to comprise any suitable material that contracts when exposed to any suitable one or more target particles. Such contraction of sensing material 160 may or may not be reversible.

For block 206, transducing platform 170 may be coupled to controller 110.

Operations for blocks 202, 204, and 206 may be performed in any suitable order and may or may not be performed so as to overlap in time the performance of any suitable operation with any other suitable operation.

Controller 110 may use sensor 150 in any suitable manner to sense the presence of a target particle in an environment near sensor 150. For one embodiment, controller 110 may use sensor 150 in accordance with a flow diagram 300 of FIG. 3.

For block 302 of FIG. 3, controller 110 uses transducing platform 170 to sense a relative volume of sensing material 160. Controller 110 may use transducing platform 170 to sense a relative volume of sensing material 160 in any suitable manner.

Controller 110 for one embodiment may sense whether the volume of sensing material 160 changed relative to a prior volume sensing. Controller 110 for one embodiment may sense whether the volume of sensing material 160 increased or decreased relative to one or more prior volume sensings. Controller 110 for one embodiment may sense the extent to which the volume of sensing material 160 increased or decreased relative to one or more prior volume sensings and/or predetermined values.

For block 304, controller 110 identifies whether a target particle is near sensing material 160 based on the sensed relative volume. Controller 110 may identify whether a target particle is near sensing material 160 in any suitable manner based on the sensed relative volume.

Controller 110 for one embodiment may identify a target particle is near sensing material 160 if the sensed volume changed from a prior volume sensing. Controller 110 for one embodiment may identify a target particle is near sensing material 160 if the sensed volume increased from one or more prior volume sensings. Controller 110 for one embodiment may identify a target particle is near sensing material 160 if the sensed volume increased by a predetermined amount from a prior volume sensing, such as an initial volume sensing for example, or from a predetermined value. Controller 110 for one embodiment may identify a target particle is near sensing material 160 if the sensed volume decreased from one or more prior volume sensings. Controller 110 for one embodiment may identify a target particle is near sensing material 160 if the sensed volume decreased by a predetermined amount from a prior volume sensing or from a predetermined value. Controller 110 for one embodiment may identify an amount or concentration of a target particle near sensing material 160 based on the extent to which the volume of sensing material 160 increased or decreased relative to one or more prior volume sensings and/or predetermined values.

If controller 110 identifies for block 304 that a target particle is near sensing material 160, controller 110 for one embodiment for block 306 may output a signal indicating the presence of a target particle to output device 120. Controller 110 for one embodiment may output a signal indicating the amount or concentration of a target particle sensed near sensing material 160. If controller 110 identifies for block 304 that a target particle is not near sensing material 160, controller 110 for one embodiment for block 308 may output a signal indicating the absence of a target particle to output device 120.

Output device 120 may comprise any suitable circuitry and/or equipment to respond to a signal output from controller 110 in any suitable manner. Output device 120 for one embodiment may provide a suitable auditory output and/or a suitable visual output in response to a signal from controller 110. Output device 120 for one embodiment may provide a suitable auditory output and/or a suitable visual output to indicate the amount or concentration of a target particle sensed near sensor 150. Output device 120 for one embodiment may provide a suitable tactile output, such as vibration for example, in response to a signal from controller 110. Output device 120 for one embodiment may actuate other circuitry and/or equipment in response to a signal from controller 110, for example, to help control a process involving a target particle or to help clear a target particle from an environment near sensor 150.

Controller 110 for one embodiment may repeat operations for blocks 302, 304, 306, and/or 308 to continue to monitor the relative volume of sensing material 160.

Sensing device 100 may perform operations for blocks 302-308 in any suitable order and may or may not overlap in time the performance of any suitable operation with any other suitable operation. Sensing device 100 for one embodiment may, for example, perform operations for blocks 302, 304, 306, and/or 308 substantially continuously or discretely at a suitable rate.

Controller 110 for another embodiment may output a signal to output device 120 for block 306 and/or block 308 generally only when the sensed relative volume of sensing material 160 changes, or changes beyond a certain amount, from a prior sensing. Controller 110 for another embodiment may output a signal to output device 120 for block 306 generally only when the absence of a target particle was identified based on a just prior sensing and/or when an identified amount or concentration of a target particle near sensing material 160 changes, or changes beyond a certain amount, from a prior sensing. Controller 110 for another embodiment may output a signal to output device 120 for block 308 generally only when the presence of a target particle was identified based on a just prior sensing.

Piezoresistive Chemical Sensor

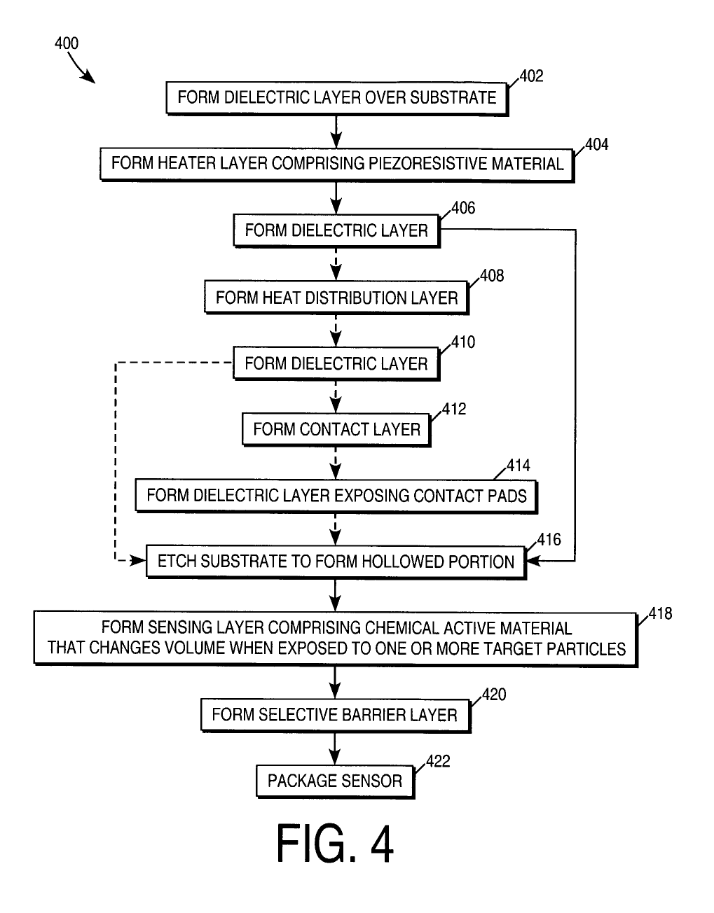

Sensor 150 for one embodiment may comprise a piezoresistive chemical sensor. FIG. 4 illustrates a flow diagram 400 summarizing embodiments to form a piezoresistive chemical sensor for blocks 202 and 204 of FIG. 2.

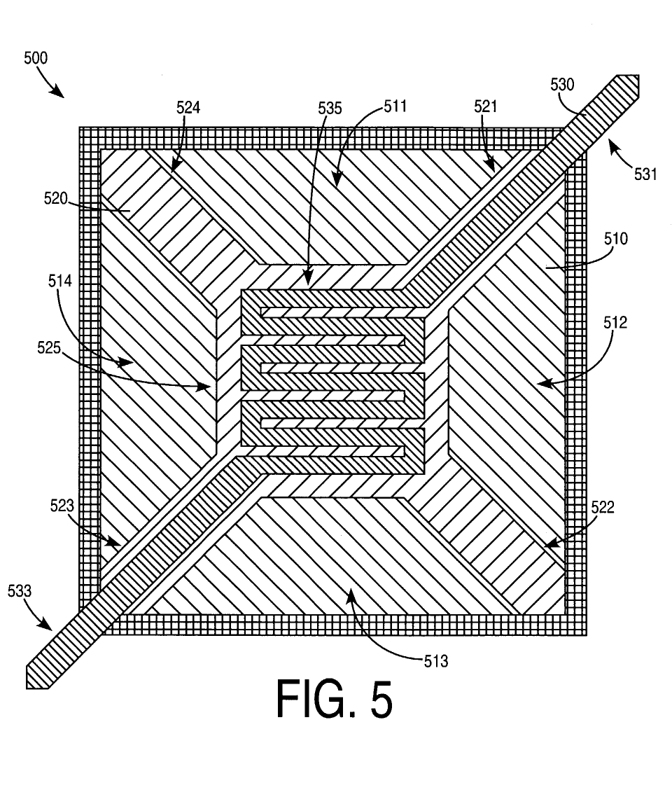

One or more embodiments of flow diagram 400 are described with reference to blocks 402, 404, 406, 416, 418, 420, and 422 of FIG. 4 and with reference to FIGS. 5, 6, and 7 to form a piezoresistive chemical sensor 600 having a sensing layer 550, corresponding to sensing material 160 of FIG. 1, over a microhotplate structure 500, corresponding to transducing platform 170 of FIG. 1. Sensing layer 550 comprises a chemical active material that changes volume when exposed to one or more target particles. Microhotplate structure 500 has a heater layer 530 to help control temperature of sensing layer 550 to help control sensitivity of sensing layer 550 to one or more target particles and/or to help control selectivity of sensing layer 550 to one or more target particles in the presence of one or more non-target particles. Heater layer 530 for one embodiment comprises a piezoelectric material to sense change in volume of sensing layer 550.

For block 402 of FIG. 4, a layer 520 comprising a dielectric material is formed over a substrate 510. Dielectric layer 520 for one embodiment may help electrically and thermally insulate heater layer 530 from substrate 510.

Substrate 510 may comprise any suitable material. For one embodiment where sensor 600 is formed at least in part using one or more metal oxide semiconductor (MOS) processing techniques, substrate 510 may comprise a suitable semiconductor material, such as silicon (Si) for example.

Dielectric layer 520 may comprise any suitable material and may be formed in any suitable manner to any suitable thickness over substrate 510. Dielectric layer 520 for one embodiment may comprise silicon dioxide (SiO₂), for example, and may be deposited using, for example, a suitable chemical vapor deposition (CVD) technique and chemistry to a thickness in the range of, for example, approximately 100 nanometers (nm) to approximately 20,000 nm. Dielectric layer 520 for another embodiment may comprise, for example, magnesium oxide (MgO), cerium oxide (CeO₂), silicon nitride (Si₃N₄), or aluminum oxide (Al₂O₃).

Dielectric layer 520 for one embodiment may be patterned in any suitable manner using any suitable technique. Dielectric layer 520 for one embodiment may be patterned using, for example, suitable photolithography and etch techniques.

Dielectric layer 520 for one embodiment may be patterned in any suitable manner to define a platform 525 over a hollowed portion 515, such as a pit for example, to be defined in substrate 510. Platform 525 may be used to help support layers of sensor 600 over hollowed portion 515 to help thermally isolate such layers from substrate 510 and to help provide a structure of suitable elasticity to yield to placement of strain on any such layer.

For one embodiment, as illustrated in FIG. 5, dielectric layer 520 may be patterned to define platform 525 with support legs 521, 522, 523, and 524 extending from platform 525 to regions of substrate 510 outside hollowed portion 515 to help support platform 525 over hollowed portion 515. Dielectric layer 520 for one embodiment may also be patterned to expose portions 511, 512, 513, and 514 of substrate 510 between support legs 521, 522, 523, and 524 to allow hollowed portion 515 to be later etched in substrate 510. Although described as having four support legs 521, 522, 523, and 524, dielectric layer 520 for another embodiment may be patterned to define one, two, three, or more than four support legs.

For block 404 of FIG. 4, heater layer 530 comprising a suitable piezoresistive material is formed over dielectric layer 520. A piezoresistive material undergoes a change in its electrical resistance under mechanical strain. Heater layer 530 for one embodiment may be used to help control temperature of one or more layers over heater layer 530 and to sense change in volume of one or more layers over heater layer 530.

Heater layer 530 may comprise any suitable piezoresistive material and may be formed in any suitable manner to any suitable thickness over dielectric layer 520. Heater layer 530 for one embodiment may comprise polycrystalline silicon (polysilicon or poly-Si), for example, and may be deposited using, for example, a suitable chemical vapor deposition (CVD) technique and chemistry or a suitable physical vapor deposition (PVD) technique. Poly-Si for one embodiment may be deposited to a thickness in the range of approximately 40 nanometers (nm) to approximately 4,000 nm, for example, to form heater layer 530.

Heater layer 530 for another embodiment may comprise, for example, a single crystal silicon (Si) heavily doped with a suitable material, such as boron (B) or a suitable Group V element for example. Group V elements include phosphorous (P), and arsenic (As), for example.

Heater layer 530 for one embodiment may be patterned in any suitable manner using any suitable technique. Heater layer 530 for one embodiment may be patterned using, for example, suitable photolithography and etch techniques.

Heater layer 530 for one embodiment may be patterned in any suitable manner to help distribute heat in heating one or more layers over heater layer 530. For one embodiment, as illustrated in FIG. 5, heater layer 530 may be patterned to define a serpentine ribbon portion 535 over platform 525. Heater layer 530 for one embodiment may also be patterned to define a suitable number of electrical leads. For one embodiment, as illustrated in FIG. 5, heater layer 530 may be patterned to define leads 531 and 533 extending from serpentine ribbon portion 535 over support legs 521 and 523, respectively.

Heater layer 530 may function as a resistive heater by inducing current flow across heater layer 530. As heater layer 530 comprises piezoresistive material, heater layer 530 for one embodiment may also function as a strain gauge to measure strain on heater layer 530 by sensing electrical resistance of heater layer 530. Because the expansion of one or more layers over heater layer 530 places a strain on heater layer 530 and because the contraction of one or more layers over heater layer 530 may release strain from heater layer 530, heater layer 530 may be used to sense change in volume of one or more layers over heater layer 530.

Heater layer 530 for one embodiment, as illustrated in FIG. 5, may be patterned to define only two leads 531 and 533 across which current may be induced to flow and across which electrical resistance may be sensed. Heater layer 530 for another embodiment may be patterned to define three, four, or more leads any suitable pair of which may be used to induce current flow through heater layer 530 and any suitable pair of which may be used to sense electrical resistance of heater layer 530. For another embodiment, heater layer 530 may be conductively coupled to a suitable number of leads under heater layer 530 and/or over heater layer 530.

Heater layer 530 for one embodiment may also be patterned to expose portions 511, 512, 513, and 514 of substrate 510 to allow hollowed portion 515 to be later etched in substrate 510.

For block 406 of FIG. 4, a layer 540 comprising a dielectric material is formed over heater layer 530. Dielectric layer 540 for one embodiment may help electrically insulate heater layer 530 from one or more layers over heater layer 530.

Dielectric layer 540 may comprise any suitable material and may be formed in any suitable manner to any suitable thickness over heater layer 530. Dielectric layer 540 for one embodiment may comprise silicon dioxide (SiO₂), for example, and may be deposited using, for example, a suitable chemical vapor deposition (CVD) technique and chemistry to a thickness in the range of, for example, approximately 70 nanometers (nm) to approximately 7,000 nm. Dielectric layer 540 for another embodiment may comprise, for example, magnesium oxide (MgO), cerium oxide (CeO₂), silicon nitride (Si₃N₄), or aluminum oxide (Al₂O₃).

Dielectric layer 540 for one embodiment may be patterned in any suitable manner using any suitable technique. Dielectric layer 540 for one embodiment may be patterned using, for example, suitable photolithography and etch techniques.

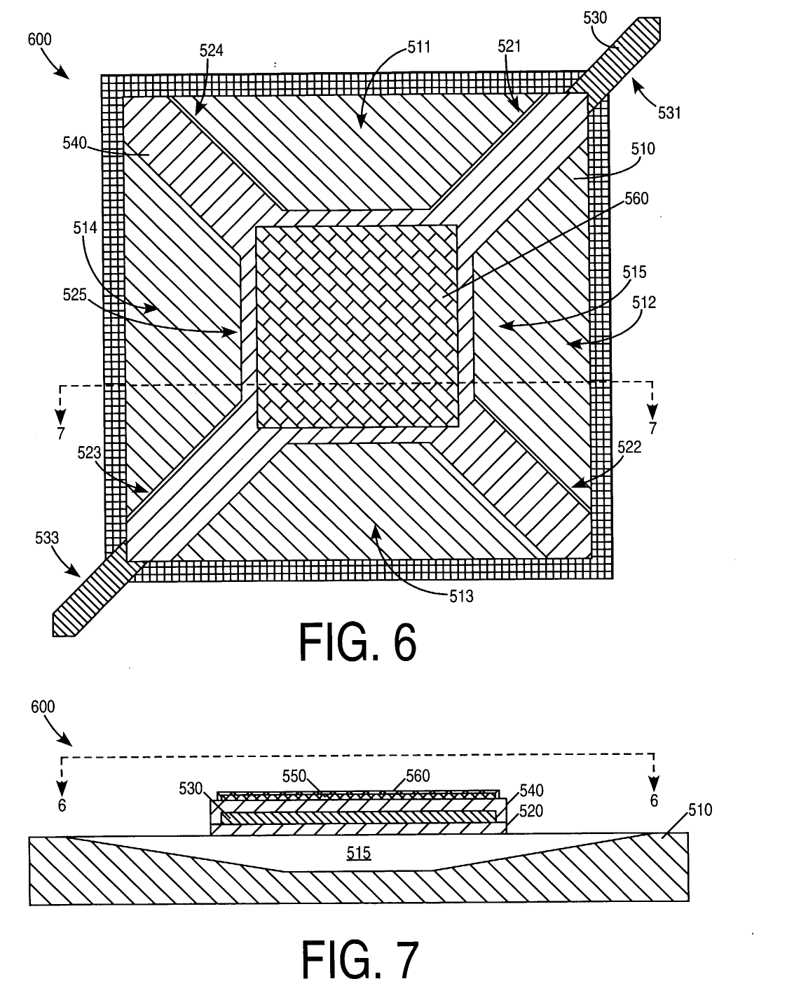

Dielectric layer 540 for one embodiment may be patterned to expose portions 511, 512, 513, and 514 of substrate 510 to allow hollowed portion 515 to be later etched in substrate 510. Dielectric layer 540 for one embodiment, as illustrated in FIG. 6, may be similarly patterned as dielectric layer 520.

For block 416 of FIG. 4, substrate 510 is etched to form hollowed portion 515. For one embodiment, as illustrated in FIGS. 6 and 7, exposed portions 511, 512, 513, and 514 of substrate 510 may be etched such that support legs 521, 522, 523, and 524 support layers on platform 525 over hollowed portion 515. Etching hollowed portion 515 for one embodiment may help thermally isolate such layers from substrate 510.

Substrate 510 may be etched in any suitable manner using any suitable etch technique to form hollowed portion 515 of any suitable size and contour. Substrate 510 for one embodiment may be etched to form hollowed portion 515 using suitable photolithography and etch techniques. Substrate 510 for one embodiment may be etched using dielectric layer 540 as a mask. For another embodiment, substrate 510 may be etched from beneath substrate 510 using a suitable backside or bulk micromachining technique to form a hollowed portion of suitable size and contour through substrate 510.

For block 418 of FIG. 4, sensing layer 550 comprising a chemical active material that changes volume when exposed to one or more target particles is formed over dielectric layer 540. Sensing layer 550 for one embodiment helps sense a target particle in an environment near sensing layer 550 by expanding in the presence of a target particle and placing strain on heater layer 530. Sensing layer 550 for one embodiment helps sense a target particle in an environment near sensing layer 550 by contracting in the presence of a target particle.

Sensing layer 550 for one embodiment may comprise any suitable chemical active material that expands when exposed to any suitable one or more target particles. Such expansion of sensing layer 550 may or may not be reversible.

Where sensing layer 550 is to sense hydrogen (H₂), for example, sensing layer 550 for one embodiment may comprise a suitable rare earth element. Rare earth elements include scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), actinium (Ac), thorium (Th), protactinium (Pa), uranium (U), neptunium (Np), plutonium (Pu), americium (Am), curium (Cm), berkelium (Bk), californium (Cf), einsteinium (Es), fermium (Fm), mendelevium (Md), nobelium (No), and lawrencium (Lr).

Sensing layer 550 for one embodiment may comprise an alloy comprising more than one suitable rare earth element. Sensing layer 550 for one embodiment may comprise an alloy of one or more suitable rare earth elements with one or more other elements. Sensing layer 550 for one embodiment may comprise an alloy of one or more suitable rare earth elements with one or more other elements that include one or more suitable Group II elements. Group II elements include magnesium (Mg), calcium (Ca), strontium (Sr), barium (Ba), and radium (Ra). Sensing layer 550 for one embodiment may comprise an alloy of one or more suitable rare earth elements with one or more other elements that include aluminum (Al), copper (Cu), cobalt (Co), and/or iridium (Ir).

Sensing layer 550 for one embodiment may comprise one or more suitable rare earth elements doped with one or more other elements. Sensing layer 550 for one embodiment may comprise one or more suitable rare earth elements doped with one or more other elements that include one or more suitable Group II elements. Sensing layer 550 for one embodiment may comprise one or more suitable rare earth elements doped with one or more other elements that include aluminum (Al), copper (Cu), cobalt (Co), and/or iridium (Ir).

Sensing layer 550 for one embodiment may comprise a suitable material having approximately 15% atomic weight or more yttrium (Y).

Where sensing layer 550 comprises, for example, a material comprising a suitable rare earth element to sense hydrogen (H₂) and is exposed to hydrogen (H₂), the hydrogen (H₂) atoms are presumably incorporated into the lattice of the material for sensing layer 550, causing the lattice to expand and therefore place strain on heater layer 530. Further exposure to hydrogen (H₂) presumably causes the lattice to expand further.

As one example where sensing layer 550 comprises yttrium (Y), for example, the exposure of yttrium (Y) to hydrogen (H₂) leads to the following chemical reaction.

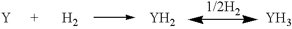

Once the irreversible formation of yttrium dihydride (YH₂) occurs, further exposure to hydrogen (H₂) results in yttrium trihydride (YH₃) which occupies a larger volume relative to yttrium dihydride (YH₂). Because the transition from yttrium dihydride (YH₂) to yttrium trihydride (YH₃) is reversible, sensing layer 550 may be restored to its yttrium dihydride (YH₂) species for re-use in sensing hydrogen (H₂) in an environment near sensing layer 550.

Other suitable elements may exhibit similar reactions with hydrogen (H₂). Sensing layer 550 for one embodiment may therefore comprise a dihydride species of one or more suitable elements.

Where sensing layer 550 is to sense hydrogen (H₂), for example, sensing layer 550 for one embodiment may comprise a suitable Group II element. Group II elements include magnesium (Mg), calcium (Ca), strontium (Sr), barium (Ba), and radium (Ra). Sensing layer 550 for one embodiment may comprise an alloy comprising more than one suitable Group II element. Sensing layer 550 for one embodiment may comprise an alloy of one or more suitable Group II elements with one or more other elements that include one or more suitable transition metals, such as manganese (Mn), iron (Fe), cobalt (Co), and/or nickel (Ni) for example. Sensing layer 550 for one embodiment may comprise a suitable magnesium-manganese (MgₓMn_{y}) alloy, a suitable magnesium-iron (MgₓFe_{y}) alloy, a suitable magnesium-cobalt (MgₓCo_{y}) alloy, or a suitable magnesium-nickel (MgₓNi_{y}) alloy. Sensing layer 550 for one embodiment may comprise one or more suitable Group II elements doped with one or more other elements.

Sensing layer 550 for one embodiment may comprise a suitable material having approximately 40% atomic weight or more magnesium (Mg).

Where sensing layer 550 is to sense hydrogen (H₂), for example, sensing layer 550 for one embodiment may comprise lithium (Li). Sensing layer 550 for one embodiment may comprise an alloy of lithium (Li) with one or more other elements. Sensing layer 550 for one embodiment may comprise a suitable Group VB element. Group VB elements include niobium (Nb) and tantalum (Ta), for example. Sensing layer 550 for one embodiment may comprise an alloy of a suitable Group VB element with one or more other elements. Sensing layer 550 for one embodiment may comprise palladium (Pd), titanium (Ti), or zirconium (Zr). Sensing layer 550 for one embodiment may comprise an alloy of palladium (Pd), titanium (Ti), or zirconium (Zr) with one or more other elements. Sensing layer 550 for one embodiment may comprise zirconium-nickel (ZrₓNi_{y}).

Sensing layer 550 for one embodiment may comprise a suitable material having approximately 11% atomic weight or more palladium (Pd). Sensing layer 550 for one embodiment may comprise a suitable material having approximately 18% atomic weight or more titanium (Ti). Sensing layer 550 for one embodiment may comprise a suitable material having approximately 16% atomic weight or more zirconium (Zr). Sensing layer 550 for one embodiment may comprise a suitable material having approximately 40% atomic weight or more zirconium-nickel (ZrₓNi_{y}).

Sensing layer 550 for one embodiment may comprise any suitable polymer or combination of polymers that changes volume when exposed to any suitable one or more target particles. Example polymers include poly(vinyl acetate)(PVA), poly(isobutylene)(PIB), poly(ethylene vinyl acetate)(PEVA), poly(4-vinylphenol), poly(styrene-co-allyl alcohol), poly(methylstyrene), poly(N-vinylpyrrolidone), poly(styrene), poly(sulfone), poly(methyl methacrylate), and poly(ethylene oxide).

Sensing layer 550 for one embodiment may comprise any suitable chemical active material that contracts when exposed to any suitable one or more target particles. Such contraction of sensing layer 550 may or may not be reversible.

Sensing layer 550 may be formed in any suitable manner to any suitable thickness over dielectric layer 540. Sensing layer 550 for one embodiment may be deposited, for example, using a suitable chemical vapor deposition (CVD) technique and chemistry, physical vapor deposition (PVD) technique, sputtering technique, solution deposition technique, focused ion beam deposition technique, electrolytic plating technique, or electroless plating technique. Suitable CVD techniques may include, for example, a suitable metal-organic CVD (MOCVD) technique or a suitable plasma-enhanced CVD (PECVD) technique. Suitable PVD techniques may include, for example, a suitable electron beam PVD (EBPVD) technique. The deposition technique used may depend, for example, on the material or materials to be used for sensing layer 550, the thickness of the material or materials to be used for sensing layer 550, and/or the temperature other materials of sensor 600 are capable of withstanding.

Where sensing layer 550 is to sense hydrogen (H₂), for example, sensing layer 550 for one embodiment may be formed to comprise a suitable hydride species of one or more suitable materials by initially exposing sensing layer 550 to hydrogen (H₂). Sensing layer 550 for another embodiment may be formed to comprise a suitable hydride species of one or more suitable materials by depositing the hydride species of one or more suitable materials to form sensing layer 550.

Sensing layer 550 for one embodiment may be formed to a thickness of less than or equal to approximately 1,000 microns. Where sensing layer 550 is to comprise yttrium (Y), for example, sensing layer 550 for one embodiment may be deposited to a thickness in the range of approximately 30 nanometers (nm) to approximately 3,000 nm, for example. The thickness of sensing layer 550 to be used may depend, for example, on the material used for sensing layer 550, the target particle(s) to be sensed with sensing layer 550, and/or the concentration of target particle(s) to be sensed with sensing layer 550.

Sensing layer 550 for one embodiment may comprise more than one sensing sublayer. Each such sublayer may be formed of any suitable material in any suitable manner to any suitable thickness. One or more sensing sublayers of sensing layer 550 may comprise any suitable chemical active material that changes volume when exposed to any suitable one or more target particles.

Sensing layer 550 for one embodiment may be patterned in any suitable manner using any suitable technique. Sensing layer 550 for one embodiment may be patterned using, for example, suitable photolithography and etch techniques.

Sensing layer 550 for one embodiment may be patterned into any suitable shape of any suitable size over platform 525. Sensing layer 550 for one embodiment may be patterned to help form a suitable shape having a surface area suitable for exposure to a target particle in an environment near sensing layer 550.

Sensing layer 550 for one embodiment may have a suitable underlying adhesion and/or diffusion barrier layer comprising a suitable material. Where, for example, dielectric layer 540 comprises silicon dioxide (SiO₂) and sensing layer 550 is to comprise yttrium (Y), an underlying layer comprising aluminum (Al), for example, may be formed.

For block 420 of FIG. 4, a selective barrier layer 560 may optionally be formed over sensing layer 550. Barrier layer 560 for one embodiment selectively allows a target particle to permeate through barrier layer 560, that is to pass from an environment near barrier layer 560 to sensing layer 550, while helping to prevent or impede one or more non-target particles from passing through barrier layer 560.

Barrier layer 560 may comprise any suitable selective barrier material. Barrier layer 560 for one embodiment may comprise a suitable material that helps prevent or impede one or more non-target particles that may be harmful to sensing layer 550 from passing through barrier layer 560. Barrier layer 560 for one embodiment may comprise a suitable material that helps prevent or impede one or more non-target particles from reacting with sensing layer 550, for example, to help prevent the formation of oxides or nitrides in sensing layer 550. Barrier layer 560 for one embodiment may comprise a suitable material that helps prevent or impede one or more non-target particles that may be falsely sensed with sensing layer 550 as a target particle from passing through barrier layer 560.

Where sensing layer 550 is to sense hydrogen (H₂), for example, barrier layer 560 for one embodiment may comprise a suitable material to prevent or impede oxygen (O), nitrogen (N), nitrogen oxides (NₓO_{y}), carbon oxides (CₓO_{y}) such as carbon monoxide (CO) for example, hydrogen sulfide (H₂S), isopropyl alcohol (IPA), ammonia, and/or hydrocarbons, for example, from passing through barrier layer 560 to sensing layer 550.

Barrier layer 560 for one embodiment may comprise a suitable material that also changes volume when exposed to one or more target particles to be sensed with sensing layer 550. Barrier layer 560 for one embodiment may therefore be a sublayer of sensing layer 550.

Where sensing layer 550 is to sense hydrogen (H₂), for example, barrier layer 560 for one embodiment may comprise a suitable noble metal. Noble metals include palladium (Pd), platinum (Pt), iridium (Ir), silver (Ag), and gold (Au).

Barrier layer 560 for one embodiment may comprise an alloy comprising more than one suitable noble metal. Barrier layer 560 for one embodiment may comprise an alloy of one or more suitable noble metals with one or more other elements. Barrier layer 560 for one embodiment may comprise an alloy of one or more suitable noble metals with one or more other elements that include magnesium (Mg), aluminum (Al), calcium (Ca), titanium (Ti), cobalt (Co), rhodium (Rh), silver (Ag), and/or iridium (Ir).

Barrier layer 560 for one embodiment may comprise one or more suitable noble metals doped with one or more other elements. Barrier layer 560 for one embodiment may comprise one or more suitable noble metals doped with one or more other elements that include magnesium (Mg), aluminum (Al), calcium (Ca), titanium (Ti), cobalt (Co), rhodium (Rh), silver (Ag), and/or iridium (Ir).

Where sensing layer 550 is to sense hydrogen (H₂), for example, barrier layer 560 for one embodiment may comprise a suitable polymeric film material, a suitable vitreous material, and/or a suitable ceramic material.

Barrier layer 560 may be formed in any suitable manner to any suitable thickness over sensing layer 550. Barrier layer 560 for one embodiment may be deposited, for example, using a suitable spraying technique, chemical vapor deposition (CVD) technique and chemistry, physical vapor deposition (PVD) technique, sputtering technique, solution deposition technique, dipping technique, focused ion beam deposition technique, electrolytic plating technique, or electroless plating technique. Suitable CVD techniques may include, for example, a suitable metal-organic CVD (MOCVD) technique or a suitable plasma-enhanced CVD (PECVD) technique. Suitable PVD techniques may include, for example, a suitable electron beam PVD (EBPVD) technique. The deposition technique used may depend, for example, on the material or materials to be used for barrier layer 560, the thickness of the material or materials to be used for barrier layer 560, and/or the temperature other materials of sensor 600 are capable of withstanding.

Where barrier layer 560 is to comprise palladium (Pd), for example, barrier layer 560 for one embodiment may be deposited to a thickness in the range of approximately 1.5 nanometers (nm) to approximately 150 nm, for example.

The thickness of barrier layer 560 to be used may depend, for example, on the material used for barrier layer 560, the target particle(s) to be sensed with sensing layer 550, and/or the concentration of target particle(s) to be sensed with sensing layer 550, noting a thicker barrier layer 560 may exhibit a relatively lower permeability of a target particle. A thinner barrier layer 560 may help in sensing lower concentrations of a target particle with sensing layer 550 while a thicker barrier layer 560 may help in sensing higher concentrations of a target particle with sensing layer 550.

Barrier layer 560 for one embodiment may comprise more than one sublayer. Each such sublayer may be formed of any suitable material in any suitable manner to any suitable thickness. Barrier layer 560 for one embodiment may comprise, for example, alternating doped and undoped noble metal sublayers. Barrier layer 560 for one embodiment may comprise an overlying barrier sublayer to help prevent degradation of barrier layer 560 due to, for example, relatively high concentrations of particles and/or catalytic poisons. Where barrier layer 560 is to allow hydrogen (H₂), for example, to pass through barrier layer 560 to sensing layer 550, the overlying barrier sublayer for one embodiment may comprise a polymer, such as a polyimide, an acrylic, nylon, a urethane, an epoxy, a fluorine containing resin, and/or polystyrene for example. The overlying barrier sublayer for another embodiment may comprise a non-polymer, such as silicon dioxide (SiO₂) or aluminum (Al) for example.

Barrier layer 560 for one embodiment may be patterned in any suitable manner using any suitable technique. Barrier layer 560 for one embodiment may be patterned using, for example, suitable photolithography and etch techniques.

Barrier layer 560 for one embodiment may be patterned into any suitable shape of any suitable size over platform 525. Barrier layer 560 for one embodiment may be patterned to help cover exposed surface area of sensing layer 550.

For block 422 of FIG. 4, sensor 600 for one embodiment may be packaged. Sensor 600 may be packaged in any suitable manner using any suitable packaging technique. Where heater layer 530 is patterned to define or is conductively coupled to only two leads, sensor 600 for one embodiment has only those two leads and may be packaged using only two wire bonds, for example. Forming sensor 600 with fewer leads may allow more sensors similar to sensor 600 to be formed on the same one substrate.

Operations for blocks 402, 404, 406, 416, 418, 420, and/or 422 of FIG. 4 may be performed in any suitable order and may or may not be performed so as to overlap in time the performance of any suitable operation with any other suitable operation. As one example, substrate 510 may be etched to form a hollowed portion for block 416 at any suitable time. As another example, sensor 600 may be packaged for block 422 prior to performing operations for block 418. Also, any other suitable operation may be performed to help form a sensor in accordance with blocks 402, 404, 406, 416, 418, 420, and/or 422 of FIG. 4. As one example, a suitable adhesion and/or barrier layer may be formed where desired.

The geometry of the support structure for platform 525, the geometry of the layers over platform 525, and the thickness, processing, and/or chemistry of materials used, for example, may influence the elastic properties of supported platform 525 and may therefore influence the strain sensitivity of heater layer 530. Sensor 600 may therefore be designed and formed as desired to help increase or decrease the strain sensitivity of heater layer 530.

Use of Piezoresistive Chemical Sensor

Sensor 600 may be used with any suitable circuitry and/or equipment in any suitable manner to sense the presence of a target particle in an environment near sensor 600.

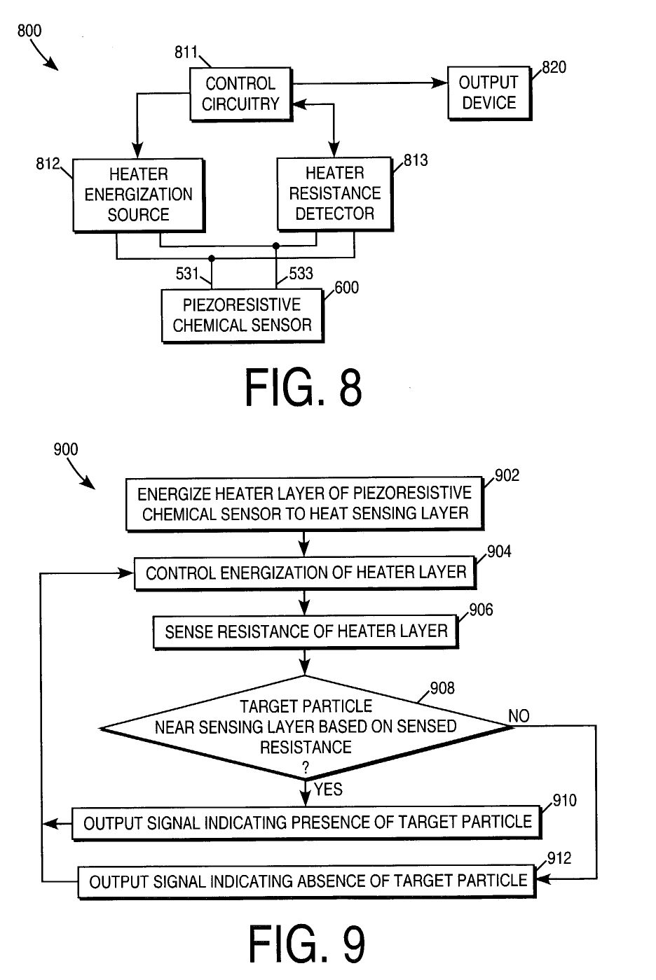

FIG. 8 illustrates, for one embodiment, a sensing device 800 comprising sensor 600, control circuitry 811, a heater energization source 812, and a heater resistance detector 813. Control circuitry 811, heater energization source 812, and heater resistance detector 813 collectively correspond to controller 110 of sensing device 100 of FIG. 1.

Control circuitry 811 is coupled to heater energization source 812 and to heater resistance detector 813. Control circuitry 811 for one embodiment may also be coupled to or in wireless communication with an output device 820. Output device 820 may or may not be a component of sensing device 800. Output device 820 corresponds to output device 120 for sensing device 100 of FIG. 1.

Heater energization source 812 and heater resistance detector 813 are each coupled to heater layer 530 of sensor 600. Heater energization source 812 may be coupled to any suitable pair of leads for heater layer 530, and heater resistance detector 813 may be coupled to any suitable pair of leads for heater layer 530. Heater energization source 812 and heater resistance detector 813 for one embodiment, as illustrated in FIG. 8, may each be coupled to leads 531 and 533 defined by heater layer 530.

Control circuitry 811 may control heater energization source 812 and heater resistance detector 813 to sense the presence of a target particle in an environment near sensor 600 in any suitable manner. Control circuitry 811 for one embodiment may control heater energization source 812 and heater resistance detector 813 to sense the presence of a target particle in an environment near sensor 600 in accordance with a flow diagram 900 of FIG. 9.

Control circuitry 811 for block 902 of FIG. 9 controls heater energization source 812 to energize heater layer 530 of sensor 600, and therefore heat sensing layer 550 of sensor 600, and for block 904 controls heater energization source 812 to control the energization of heater layer 530 to help control temperature of sensing layer 550. Control circuitry 811 for one embodiment may heat sensing layer 550 to help increase the rate of interaction of material of sensing layer 550 with a target particle and therefore enhance the sensitivity of sensing layer 550 to a target particle. Heating sensing layer 550 for one embodiment may therefore help in sensing relatively lower concentrations of a target particle with sensing layer 550 and/or help increase the response speed of sensing layer 550. Heating sensing layer 550 for one embodiment may help enhance selectivity of sensing layer 550 to one or more target particles in the presence of one or more non-target particles.

Heater energization source 812 may comprise any suitable circuitry to energize heater layer 530 in any suitable manner. Heater energization source 812 for one embodiment may comprise a voltage source and energize heater layer 530 by applying a suitable voltage across heater layer 530 to induce current flow through heater layer 530. Heater energization source 812 for another embodiment may comprise a current source to induce current flow through heater layer 530.

Control circuitry 811 may comprise any suitable circuitry to control heater energization source 812 in any suitable manner to energize heater layer 530 and to control the energization of heater layer 530 in any suitable manner. Control circuitry 811 for one embodiment may control heater energization source 812 to pulse heater layer 530 at a predetermined rate, for example, to help consume less power. Control circuitry 811 for one embodiment may comprise a suitable data processing unit to control the energization of heater layer 530 in accordance with a suitable predetermined temperature program.

For block 906, control circuitry 811 controls heater energization source 812 and/or heater resistance detector 813 to sense electrical resistance of heater layer 530 and therefore sense the relative volume of sensing layer 550. Heater resistance detector 813 may comprise any suitable circuitry to sense resistance of heater layer 530 in any suitable manner.

Where heater energization source 812 comprises a current source capable of generating a relatively constant current flow through heater layer 530, heater resistance detector 813 for one embodiment may comprise a voltage detector to measure a voltage across heater layer 530. Because resistance is equal to voltage divided by current, that is R=V/I, and because the amount of current flow through heater layer 530 may be held relatively constant, heater resistance detector 813 may effectively sense resistance of heater layer 530 by measuring voltage across heater layer 530.

Where heater energization source 812 comprises a voltage source capable of generating a relatively constant voltage across heater layer 530, heater resistance detector 813 for one embodiment may comprise a current detector and may effectively sense resistance of heater layer 530 by measuring current flow through heater layer 530.

Control circuitry 811 for one embodiment may control heater energization source 812 and heater resistance detector 813 that together form a resistor bridge circuit to measure resistance of heater layer 530.

Control circuitry 811 for one embodiment may control heater energization source 812 and heater resistance detector 813 to form an active feedback system that can change voltage across heater layer 530 and/or that can change current through heater layer 530 and monitor the current-voltage relationship of heater layer 530 to measure resistance of heater layer 530.

For block 908, control circuitry 811 identifies whether a target particle is near sensing layer 550 of sensor 600 based on the sensed resistance. Control circuitry 811 may identify whether a target particle is near sensing layer 550 in any suitable manner based on the sensed resistance.

Control circuitry 811 for one embodiment may compare the sensed resistance, for example a measured voltage, a measured current, or a measured resistance for heater layer 530, to one or more prior sensed and/or predetermined values to identify whether a target particle is near sensing layer 550 and/or to identify an amount or concentration of a target particle near sensing layer 550.

If control circuitry 811 identifies for block 908 that a target particle is near sensing layer 550, control circuitry 811 for one embodiment for block 910 may output a signal indicating the presence of a target particle to output device 820. Control circuitry 811 for one embodiment may output a signal indicating the amount or concentration of a target particle sensed near sensing layer 550. If control circuitry 811 identifies for block 908 that a target particle is not near sensing layer 550, control circuitry 811 for one embodiment for block 912 may output a signal indicating the absence of a target particle to output device 820.

Control circuitry 811 for one embodiment may repeat operations for blocks 904, 906, 908, 910, and/or 912 to continue to help control temperature of sensing layer 550 and monitor resistance of heater layer 530. Control circuitry 811 for one embodiment for block 904 may also control the energization of heater layer 530 to help refresh the sensing capability of sensing layer 550. Where sensing layer 550 comprises a material that undergoes a reversible reaction with hydrogen (H₂), for example, by changing from a dihydride species to a trihydride species, for example, control circuitry 811 for one embodiment may control heater energization source 812 to control the energization of heater layer 530 to help return the material to its dihydride species. Control circuitry 811 for one embodiment may control heater energization source 812 to heat sensing layer 550 to one temperature for enhanced sensitivity and/or selectivity and to a higher temperature to refresh the sensing capability of sensing layer 550.

Sensing device 800 may perform operations for blocks 902-912 in any suitable order and may or may not overlap in time the performance of any suitable operation with any other suitable operation. Sensing device 800 for one embodiment may, for example, perform operations for blocks 904, 906, 908, 910, and/or 912 substantially continuously or discretely at a suitable rate.

Control circuitry 811 for another embodiment may output a signal to output device 820 for block 910 and/or block 912 generally only when the sensed resistance of heater layer 530 changes, or changes beyond a certain amount, from a prior sensed resistance. Control circuitry 811 for another embodiment may output a signal to output device 820 for block 910 generally only when the absence of a target particle was identified based on a just prior sensed resistance and/or when an identified amount or concentration of a target particle near sensing layer 550 changes, or changes beyond a certain amount, from a prior sensed resistance. Control circuitry 811 for another embodiment may output a signal to output device 820 for block 912 generally only when the presence of a target particle was identified based on a just prior sensed resistance.

Optional Heat Distribution Layer

Referring to FIG. 4, one or more embodiments of flow diagram 400 are described with reference to blocks 402, 404, 406, 408, 410, 416, 418, 420, and 422 and with reference to FIGS. 5, 10, and 11 to form a piezoresistive chemical sensor 1100 having sensing layer 550 over a microhotplate structure 1000 having a heat distribution layer 570. Heat distribution layer 570 helps distribute heat evenly from heater layer 530 to sensing layer 550.

After dielectric layer 540 is formed over heater layer 530 for block 406 of FIG. 4, heat distribution layer 570 may be formed for block 408 over dielectric layer 540.

Heat distribution layer 570 may comprise any suitable material and may be formed in any suitable manner to any suitable thickness over dielectric layer 540. Heat distribution layer 570 for one embodiment may comprise a suitable conductive material, such as aluminum (Al) or copper (Cu) for example, and may be deposited using, for example, a suitable chemical vapor deposition (CVD) technique and chemistry, a suitable physical vapor deposition (PVD) technique, or a suitable electrolytic plating technique to a thickness in the range of, for example, approximately 30 nanometers (nm) to approximately 6,000 nm.

Heat distribution layer 570 may be patterned in any suitable manner using any suitable technique. Heat distribution layer 570 for one embodiment may be patterned using, for example, suitable photolithography and etch techniques. Heat distribution layer 570 for one embodiment may be formed using a suitable dual damascene technique and therefore patterned as heat distribution layer 570 is formed.

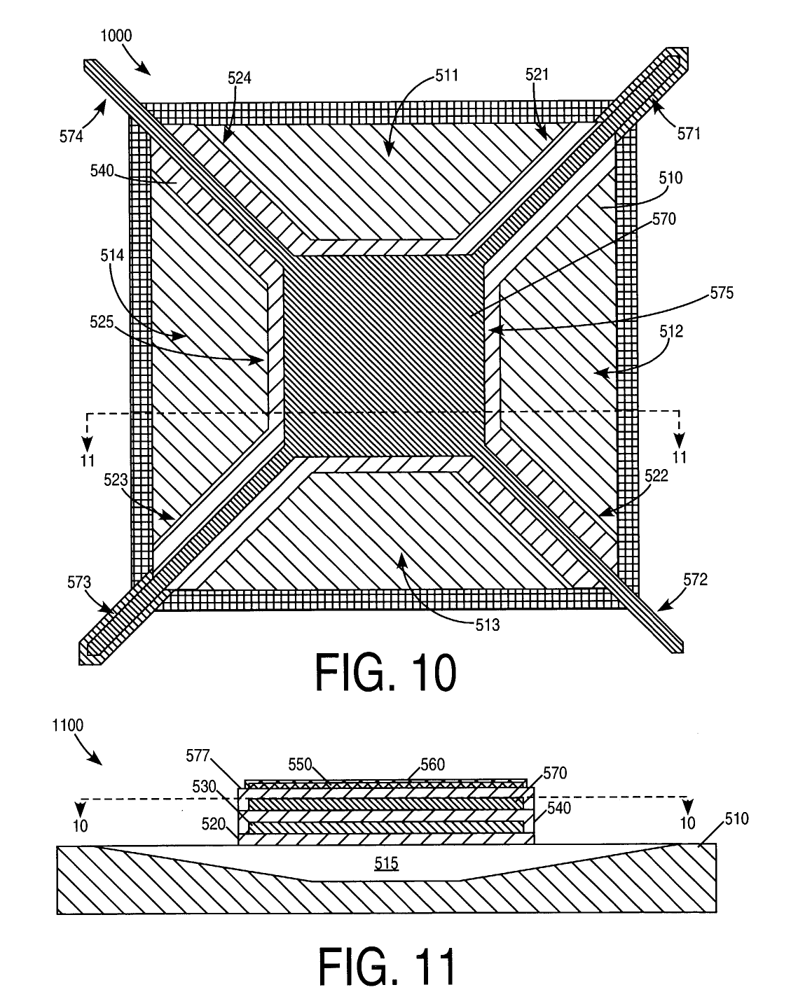

Heat distribution layer 570 for one embodiment may be patterned in any suitable manner to help distribute heat evenly to one or more layers over heat distribution layer 570. For one embodiment, as illustrated in FIG. 10, heat distribution layer 570 may be patterned to define a substantially uniform portion 575 of a suitable shape over platform 525.

Heat distribution layer 570 for one embodiment may also be patterned to define a suitable number of electrical leads. In this manner, heat distribution layer 570 for one embodiment may be used to help monitor temperature near sensing layer 550 by inducing current flow through heat distribution layer 570 and sensing electrical resistance of heat distribution layer 570 to identify a temperature near sensing layer 550. The identified temperature may be used, for example, to help control the energization of heater layer 530. Sensing device 800 of FIG. 8, for example, may be modified to sense a target particle with sensor 1100 by using an energization source and resistance detector under control of control circuitry 811 to identify a temperature near sensing layer 550 using heat distribution layer 570.

Heat distribution layer 570 for one embodiment, as illustrated in FIG. 10, may be patterned to define leads 571, 572, 573, and 574 extending from portion 575 over support legs 521, 522, 523, and 524, respectively. Any suitable pair of leads 571, 572, 573, and 574 may be used to induce current flow through heat distribution layer 570. Any suitable pair of leads 571, 572, 573, and 574 may be used to sense electrical resistance of heat distribution layer 570. Heat distribution layer 570 for another embodiment may be patterned to define only two, three, or more leads. For another embodiment, heat distribution layer 570 may be conductively coupled to a suitable number of leads under heat distribution layer 570 and/or over heat distribution layer 570. For one embodiment, heat distribution layer 570 may have one or more leads conductively coupled to one or more leads for one or more other layers, such as heater layer 530 for example, to help define one or more common leads, such as a ground lead for example, for multiple layers and therefore to help reduce the number of leads for sensor 1100. Heat distribution layer 570 for one embodiment may also be patterned to expose portions 511, 512, 513, and 514 of substrate 510 to allow hollowed portion 515 to be later etched in substrate 510.

For block 410 of FIG. 4, a layer 577 comprising a dielectric material may be formed over heat distribution layer 570. Dielectric layer 577 for one embodiment may help electrically insulate heat distribution layer 570 from one or more layers over heat distribution layer 570. The description pertaining to the formation and patterning of dielectric layer 540 for block 406 similarly applies to the formation and patterning of dielectric layer 577 for block 410.

The geometry of heat distribution layer 570 and dielectric layer 577 and the thickness, processing, and/or chemistry of materials used, for example, may influence the elastic properties of supported platform 525 and may therefore influence the strain sensitivity of heater layer 530. Sensor 1100 may therefore be designed and formed as desired to help increase or decrease the strain sensitivity of heater layer 530.

Operations for blocks 402, 404, 406, 408, 410, 416, 418, 420, and/or 422 of FIG. 4 may be performed in any suitable order and may or may not be performed so as to overlap in time the performance of any suitable operation with any other suitable operation. As one example, substrate 510 may be etched to form a hollowed portion for block 416 at any suitable time. As another example, sensor 600 may be packaged for block 422 prior to performing operations for block 418. Also, any other suitable operation may be performed to help form a sensor in accordance with blocks 402, 404, 406, 408, 410, 416, 418, 420, and/or 422 of FIG. 4. As one example, a suitable adhesion and/or barrier layer may be formed where desired.

Optional Contact Layer

Referring to FIG. 4, one or more embodiments of flow diagram 400 are described with reference to blocks 402, 404, 406, 408, 410, 412, 414, 416, 418, 420, and 422 and with reference to FIGS. 5, 12, and 13 to form a piezoresistive chemical sensor 1300 having sensing layer 550 over a microhotplate structure 1200 having a contact layer defining contacts 581, 582, 583, and 584 to be conductively coupled to sensing layer 550. The contact layer for one embodiment may be used to help energize sensing layer 550 to help control sensitivity of sensing layer 550 to one or more target particles and/or to help control selectivity of sensing layer 550 to one or more target particles in the presence of one or more non-target particles. Where sensing layer 550 is to comprise a material that undergoes a change in its electrical properties in reacting with one or more target particles, the contact layer for one embodiment may be used to help sense electrical resistance of sensing layer 550 to help identify whether a target particle is near sensing layer 550.

After dielectric layer 577 is formed over heat distribution layer 570 for block 410 of FIG. 4, the contact layer may be formed for block 412 over dielectric layer 577.

The contact layer may comprise any suitable material and may be formed in any suitable manner to any suitable thickness over dielectric layer 577. The contact layer for one embodiment may comprise a suitable conductive material, such as aluminum (Al), copper (Cu), platinum (Pt), or tungsten (W) for example, and may be deposited using, for example, a suitable chemical vapor deposition (CVD) technique and chemistry, a suitable physical vapor deposition (PVD) technique, or a suitable electrolytic plating technique to a thickness in the range of, for example, approximately 30 nanometers (nm) to approximately 6,000 nm.

The contact layer may be patterned in any suitable manner using any suitable technique to define contacts 581, 582, 583, and 584. The contact layer for one embodiment may be patterned using, for example, suitable photolithography and etch techniques. The contact layer for one embodiment may be formed using a suitable dual damascene technique and therefore patterned as the contact layer is formed.

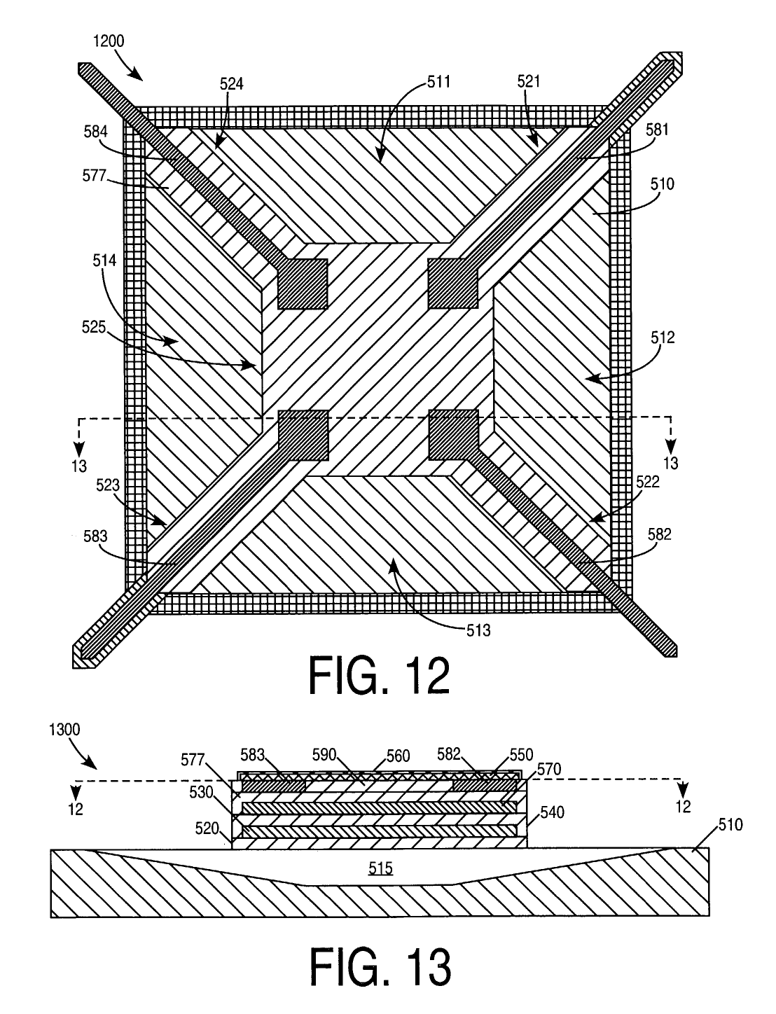

For one embodiment, as illustrated in FIG. 12, the contact layer may be patterned to define for each contact 581, 582, 583, and 584 a pad over at least a portion of platform 525 and an electrical lead extending from the pad over support leg 521, 522, 523, and 524, respectively. Where sensing layer 550 is to comprise a material that undergoes a change in its electrical properties in reacting with one or more target particles, sensing layer 550 for one embodiment may be formed over the pads for conductive coupling to contacts 581, 582, 583, and 584. Any suitable pair of contacts 581, 582, 583, and 584 may then be used to induce current flow through sensing layer 550. Any suitable pair of contacts 581, 582, 583, and 584 may be used to sense electrical resistance of sensing layer 550 to help identify whether a target particle is near sensing layer 550.

As one example, sensing layer 550 may comprise yttrium dihydride (YH₂). Upon exposure to hydrogen (H₂), yttrium dihydride (YH₂) will react to form yttrium trihydride (YH₃) which has a greater electrical resistance. Whether hydrogen (H₂) is near sensing layer 550 may then be identified by sensing resistance of sensing layer 550. Other suitable elements may exhibit similar reactions with hydrogen (H₂).

Although described as having four contacts 581, 582, 583, and 584, the contact layer for another embodiment may be patterned to define only two, three, or more contacts. For one embodiment, the contact layer may be patterned to define one or more contacts for conductive coupling to one or more leads for one or more other layers, such as heater layer 530 and/or heat distribution layer 570 for example, to help define one or more common leads, such as a ground lead for example, for multiple layers and therefore to help reduce the number of leads for sensor 1300.

For block 414 of FIG. 4, a layer 590 comprising a dielectric material may be formed over contacts 581, 582, 583, and 584 and patterned to expose at least a portion of the pads of contacts 581, 582, 583, and 584. The description pertaining to the formation and patterning of dielectric layer 540 for block 406 similarly applies to the formation and patterning of dielectric layer 590 for block 414. Dielectric layer 590 for one embodiment may be planarized using a suitable chemical-mechanical polishing (CMP) technique, for example. Dielectric layer 590 for one embodiment may be formed as part of a suitable dual damascene technique to form the contact layer.

For block 418 of FIG. 4, sensing layer 550 may be formed over exposed portions of contacts 581, 582, 583, and 584. Sensing layer 550 for one embodiment may have a suitable underlying adhesion and/or diffusion barrier layer comprising a suitable material. Where, for example, contacts 581, 582, 583, and 584 comprise aluminum (Al), dielectric layer 590 comprises silicon dioxide (SiO₂), and sensing layer 550 is to comprise yttrium (Y), an underlying layer comprising aluminum (Al), for example, may be formed.

The geometry of contacts 581, 582, 583, and 584 and dielectric layer 590 and the thickness, processing, and/or chemistry of materials used, for example, may influence the elastic properties of supported platform 525 and may therefore influence the strain sensitivity of heater layer 530. Sensor 1300 may therefore be designed and formed as desired to help increase or decrease the strain sensitivity of heater layer 530.

Operations for blocks 402, 404, 406, 408, 410, 412, 414, 416, 418, 420, and/or 422 of FIG. 4 may be performed in any suitable order and may or may not be performed so as to overlap in time the performance of any suitable operation with any other suitable operation. As one example, substrate 510 may be etched to form a hollowed portion for block 416 at any suitable time. As another example, sensor 600 may be packaged for block 422 prior to performing operations for block 418. Also, any other suitable operation may be performed to help form a sensor in accordance with blocks 402, 404, 406, 408, 410, 412, 414, 416, 418, 420, and/or 422 of FIG. 4. As one example, a suitable adhesion and/or barrier layer may be formed where desired.

Although described as having the contact layer formed prior to forming sensing layer 550, sensor 1300 for another embodiment may have sensing layer 550 formed over dielectric layer 577 and the contact layer formed over sensing layer 550. Dielectric layer 590 for this embodiment may be formed over the contact layer and patterned to expose sensing layer 550 or may not be formed at all.

Although described as comprising heat distribution layer 570 and dielectric layer 577, sensor 1300 for another embodiment may not comprise heat distribution layer 570 or dielectric layer 577.

Use of Piezoresistive Chemical Sensor with Contact Layer

Sensor 1300 may be used with any suitable circuitry and/or equipment in any suitable manner to sense the presence of a target particle in an environment near sensor 1300.

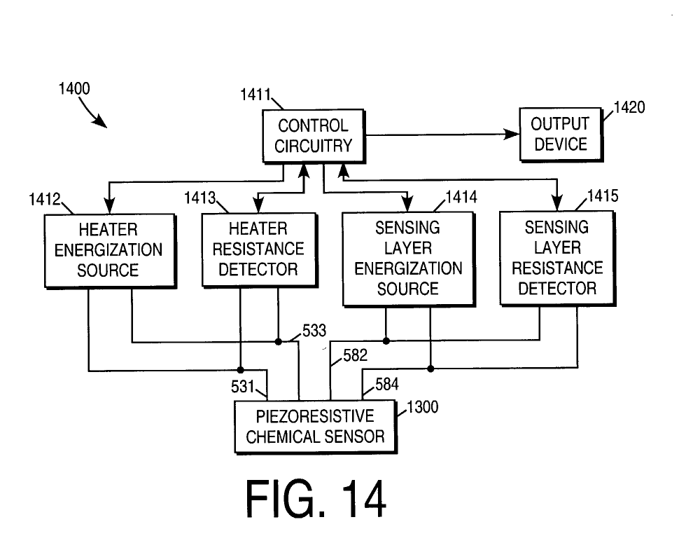

FIG. 14 illustrates, for one embodiment, a sensing device 1400 comprising sensor 1300, control circuitry 1411, a heater energization source 1412, a heater resistance detector 1413, a sensing layer energization source 1414, and a sensing layer resistance detector 1415. Control circuitry 1411, heater energization source 1412, heater resistance detector 1413, sensing layer energization source 1414, and sensing layer resistance detector 1415 collectively correspond to controller 110 of sensing device 100 of FIG. 1.

Control circuitry 1411 is coupled to heater energization source 1412, to heater resistance detector 1413, to sensing layer energization source 1414, and to sensing layer resistance detector 1415. Control circuitry 1411 for one embodiment may also be coupled to or in wireless communication with an output device 1420. Output device 1420 may or may not be a component of sensing device 1400. Output device 1420 corresponds to output device 120 for sensing device 100 of FIG. 1.

Control circuitry 1411, heater energization source 1412, and heater resistance detector 1413 generally correspond to control circuitry 811, heater energization source 812, and heater resistance detector 813, respectively, of sensing device 800 of FIG. 8. The description of sensing device 800 of FIG. 8 may therefore similarly apply to sensing device 1400 of FIG. 14 where applicable.

Sensing layer energization source 1414 and sensing layer resistance detector 1415 are each coupled to sensing layer 550 of sensor 1300. Sensing layer energization source 1414 may be coupled to any suitable pair of contacts of sensor 1300, and sensing layer resistance detector 1415 may be coupled to any suitable pair of contacts of sensor 1300. Sensing layer energization source 1414 and sensing layer resistance detector 1415 for one embodiment, as illustrated in FIG. 14, may each be coupled to contacts 582 and 584.

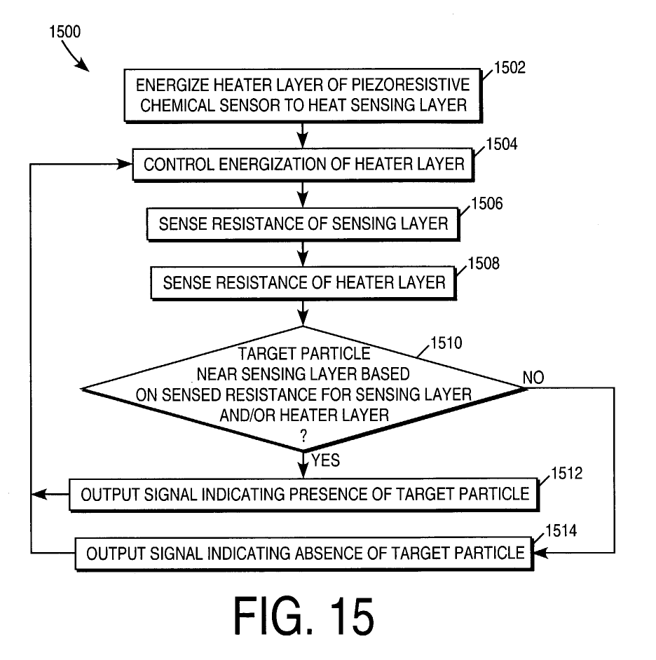

Control circuitry 1411 may control heater energization source 1412, heater resistance detector 1413, sensing layer energization source 1414, and sensing layer resistance detector 1415 to sense the presence of a target particle in an environment near sensor 1300 in any suitable manner. Control circuitry 1411 for one embodiment may control heater energization source 1412, heater resistance detector 1413, sensing layer energization source 1414, and sensing layer resistance detector 1415 to sense the presence of a target particle in an environment near sensor 1300 in accordance with a flow diagram 1500 of FIG. 15.

Blocks 1502, 1504, 1508, 1510, 1512, and 1514 of flow diagram 1500 of FIG. 15 generally correspond to blocks 902, 904, 906, 908, 910, and 912, respectively, of flow diagram 900 of FIG. 9. The description of flow diagram 900 of FIG. 9 may therefore similarly apply to flow diagram 1500 of FIG. 15 where applicable.

For block 1502 of FIG. 15, control circuitry 1411 controls heater energization source 1412 to energize heater layer 530 of sensor 1300 and therefore heat sensing layer 550 of sensor 1300. Control circuitry 1411 for block 1504 controls heater energization source 1412 to control the energization of heater layer 530 to help control temperature of sensing layer 550.

For block 1506, control circuitry 1411 controls sensing layer energization source 1414 to energize sensing layer 550 of sensor 1300 and controls sensing layer resistance detector 1415 to sense electrical resistance of sensing layer 550. Sensing layer energization source 1414 may comprise any suitable circuitry to energize sensing layer 550 in any suitable manner, and sensing layer resistance detector 1415 may comprise any suitable circuitry to sense resistance of sensing layer 550 in any suitable manner. The description of heater energization source 812 and heater resistance detector 813 of FIG. 8 may similarly apply to sensing layer energization source 1414 and sensing layer resistance detector 1415 of FIG. 14 where applicable.

For block 1508, control circuitry 1411 controls heater energization source 1412 and/or heater resistance detector 1413 to sense electrical resistance of heater layer 530.

For block 1510, control circuitry 1411 identifies whether a target particle is near sensing layer 550 of sensor 1300 based on the sensed resistance of sensing layer 550 and/or based on the sensed resistance of heater layer 530. Control circuitry 1411 may identify whether a target particle is near sensing layer 550 in any suitable manner based on the sensed resistance of either or both sensing layer 550 and heater layer 530.

Control circuitry 1411 for one embodiment may compare the sensed resistance, for example a measured voltage, a measured current, or a measured resistance, of sensing layer 550 to one or more prior sensed and/or predetermined values and the sensed resistance of heater layer 530 to one or more prior sensed and/or predetermined values to identify whether a target particle is near sensing layer 550 and/or to identify an amount or concentration of a target particle near sensing layer 550.

Control circuitry 1411 for one embodiment may identify that a target particle is near sensing layer 550 if either one or both comparisons identify that a target particle is near sensing layer 550. Control circuitry 1411 for one embodiment may identify an amount or concentration of a target particle near sensing layer 550 based on either or both of the sensed resistances of sensing layer 550 and heater layer 530. Control circuitry 1411 for one embodiment may use the sensed resistance of sensing layer 550 to identify an amount or concentration of a target particle near sensing layer 550 for relatively low sensed amounts or concentrations of a target particle and may use the sensed resistance of heater layer 530 to identify an amount or concentration of a target particle near sensing layer 550 for relatively high sensed amounts or concentrations of a target particle.

If control circuitry 1411 identifies for block 1510 that a target particle is near sensing layer 550, control circuitry 1411 for one embodiment for block 1512 may output a signal indicating the presence of a target particle to output device 1420. Control circuitry 1411 for one embodiment may output a signal indicating the amount or concentration of a target particle sensed near sensing layer 550. If control circuitry 1411 identifies for block 1510 that a target particle is not near sensing layer 550, control circuitry 1411 for one embodiment for block 1514 may output a signal indicating the absence of a target particle to output device 1420.

Control circuitry 1411 for one embodiment may repeat operations for blocks 1504, 1506, 1508, 1510, 1512 and/or 1514 to continue to help control temperature of sensing layer 550 and monitor resistances of sensing layer 550 and heater layer 530. Control circuitry 1411 for one embodiment for block 1504 may also control the energization of heater layer 530 to help refresh the sensing capability of sensing layer 550.

Although illustrated as physically separate components, heater energization source 1412 and sensing layer energization source 1414 for one embodiment may comprise common circuitry to energize heater layer 530 and sensing layer 550, respectively, under control of control circuitry 1411. Heater resistance detector 1413 and sensing layer resistance detector 1415 for one embodiment may comprise common circuitry to sense resistance of heater layer 530 and sensing layer 550, respectively, under control of control circuitry 1411.

Sensing device 1400 may perform operations for blocks 1502-1514 in any suitable order and may or may not overlap in time the performance of any suitable operation with any other suitable operation. Sensing device 1400 for one embodiment may, for example, perform operations for block 1506 while and/or after performing operations for block 1508. Sensing device 1400 for one embodiment may, for example, perform operations for blocks 1504, 1506, 1508, 1510, 1512, and/or 1514 substantially continuously or discretely at a suitable rate.

Control circuitry 1411 for another embodiment may control sensing layer energization source 1414 to energize sensing layer 550 and to control energization of sensing layer 550 to help control sensitivity of sensing layer 550 to one or more target particles and/or to help control selectivity of sensing layer 550 to one or more target particles in the presence of one or more non-target particles. Sensing device 1400 for this embodiment may or may not comprise and/or may or may not use sensing layer resistance detector 1415.

Control circuitry 1411 for another embodiment may output a signal to output device 1420 for block 1512 and/or block 1514 generally only when the sensed resistance of heater layer 530 changes, or changes beyond a certain amount, from a prior sensed resistance and/or when the sensed resistance of sensing layer 550 changes, or changes beyond a certain amount, from a prior sensed resistance. Control circuitry 1411 for another embodiment may output a signal to output device 1420 for block 1512 generally only when the absence of a target particle was identified based on just prior sensed resistances and/or when an identified amount or concentration of a target particle near sensing layer 550 changes, or changes beyond a certain amount, from prior sensed resistances. Control circuitry 1411 for another embodiment may output a signal to output device 1420 for block 1514 generally only when the presence of a target particle was identified based on just prior sensed resistances.

Microcantilever Structure for Transducing Platform

Although described in connection with microhotplate structure 500 of FIG. 5, embodiments of flow diagram 400 of FIG. 4 may also be used to form a piezoresistive chemical sensor having a suitable microcantilever structure for transducing platform 170 of FIG. 1.

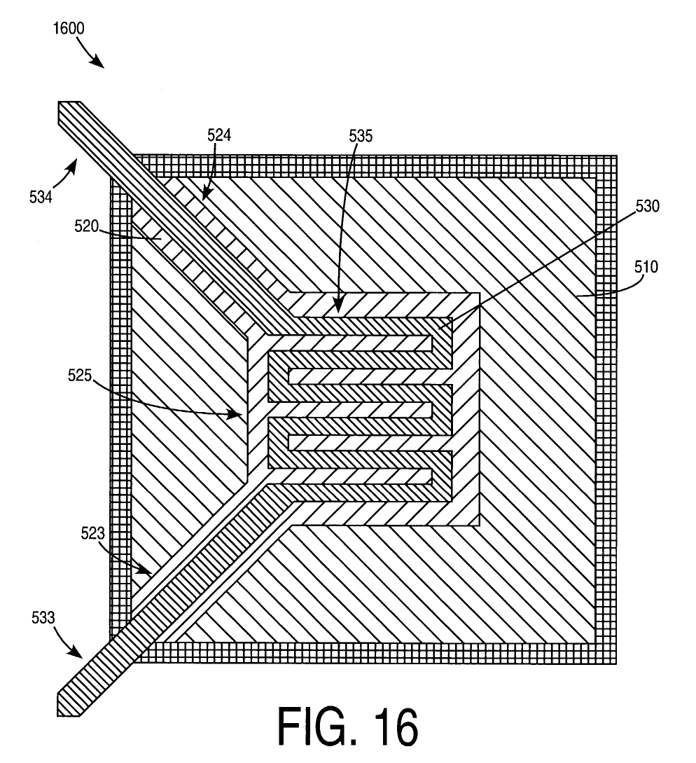

FIG. 16 illustrates, for one embodiment, a microcantilever structure 1600 that may be formed in accordance with embodiments of flow diagram 400 of FIG. 4. A cross-section of a piezoresistive chemical sensor formed in accordance with blocks 402, 404, 406, 416, 418, 420, and 422 of FIG. 4 to have microcantilever structure 1600 for one embodiment may appear similarly as the cross-section of sensor 600 of FIG. 6. Microcantilever structure 1600 is formed by defining platform 525 to be bendable or deflectable along a suitable bend axis in response to placement of strain on one or more layers over platform 525. Because the electrical resistance of the piezoresistive material of heater layer 530 over platform 525 changes as platform 525 is deflected to bend toward hollowed portion 515 or rebounds away from hollowed portion 515, change in volume of sensing layer 550 may be sensed by sensing electrical resistance of heater layer 530 on platform 525.

Microcantilever structure 1600 for one embodiment may be formed by patterning dielectric layer 520 for block 402 of FIG. 4 to define one or more support legs to support platform 525 over hollowed portion 515 in substrate 510 while allowing platform 525 to be bent or deflected along a suitable bend axis in response to change in volume of one or more layers over platform 525. Dielectric layer 520 may be patterned in any suitable manner. Dielectric layer 520 for one embodiment, as illustrated in FIG. 16, may be patterned to define support legs 523 and 524 extending outward from adjacent corners of platform 525. Dielectric layer 520 for another embodiment may be patterned to define one or more support legs extending outward from the same one side of platform 525.

Heater layer 530 for one embodiment may then be formed and patterned for block 404 of FIG. 4 in any suitable manner to define a portion of a suitable shape, such as serpentine ribbon portion 535 for example, over platform 525 and/or to define two or more electrical leads for heater layer 530. For one embodiment, as illustrated in FIG. 16, heater layer 530 may be patterned to define leads 533 and 534 extending from serpentine ribbon portion 535 over support legs 523 and 524, respectively.

The geometry of the support structure for platform 525, the geometry of the layers over platform 525, and the thickness, processing, and/or chemistry of materials used, for example, may influence the elastic properties of supported platform 525 and may therefore influence the strain sensitivity of heater layer 530. A sensor having microcantilever structure 1600 may therefore be designed and formed as desired to help increase or decrease the strain sensitivity of heater layer 530.

Diaphragm Structure for Transducing Platform

Embodiments of flow diagram 400 of FIG. 4 may also be used to form a piezoresistive chemical sensor having a suitable diaphragm structure for transducing platform 170 of FIG. 1.

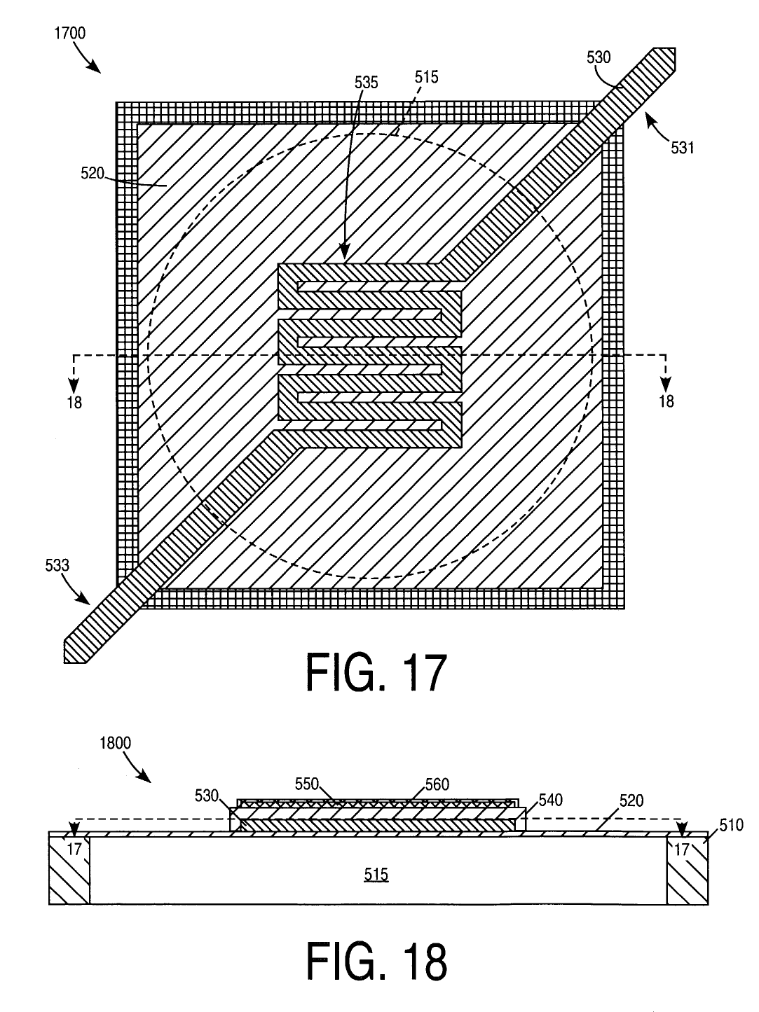

FIG. 17 illustrates, for one embodiment, a diaphragm structure 1700 that may be formed in accordance with embodiments of flow diagram 400 of FIG. 4. FIG. 18 illustrates, for one embodiment, a piezoresistive chemical sensor 1800 formed in accordance with blocks 402, 404, 406, 416, 418, 420, and 422 of FIG. 4 to have diaphragm structure 1700. Diaphragm structure 1700 is formed by defining a membrane layer to span a hollowed portion of substrate 510 to help thermally isolate layers over the membrane layer from substrate 510 and to provide a structure of suitable elasticity to yield to placement of strain on any such layer.

Diaphragm structure 1700 for one embodiment, as illustrated in FIGS. 17 and 18, may be formed by forming dielectric layer 520 over substrate 510 for block 402 of FIG. 4 and etching substrate 510 from its backside for block 416 to form hollowed portion 515 in substrate 510 with dielectric layer 520 spanning hollowed portion 515 to serve as a membrane layer.

Dielectric layer 520 may comprise any suitable material and may be formed to any suitable thickness to define a membrane layer of any suitable thickness over hollowed portion 515. Dielectric layer 520 for one embodiment may comprise silicon dioxide (SiO₂), silicon nitride (Si₃N₄), or a suitable polymer, for example, and may be formed to a suitable thickness over substrate 510 to define a membrane layer having a thickness in the range of, for example, approximately 0.4 microns (μm) to approximately 2,000 μm.

Substrate 510 may be etched in any suitable manner using any suitable etch technique to form hollowed portion 515 of any suitable size and contour. Substrate 510 for one embodiment may be etched using a suitable selective etch chemistry that allows dielectric layer 520 to help serve as an etch stop. Substrate 510 for one embodiment may be etched using a suitable backside or bulk micromachining technique to form hollowed portion 515.

Heater layer 530 for one embodiment may be formed over dielectric layer 520 and patterned for block 404 of FIG. 4 in any suitable manner to define a portion of a suitable shape, such as serpentine ribbon portion 535 for example, over dielectric layer 520 and/or to define two or more electrical leads for heater layer 530. For one embodiment, as illustrated in FIG. 17, heater layer 530 may be patterned to define leads 531 and 533 extending from serpentine ribbon portion 535.

For another embodiment, substrate 510 may be etched to define a membrane layer from substrate 510 itself over a hollowed portion in substrate 510. Substrate 510 may comprise any suitable material, such as silicon (Si) for example, and may be processed in any suitable manner to define a membrane layer of any suitable thickness over a hollowed portion of any suitable size and contour in substrate 510. Substrate 510 for one embodiment may be subjected to a suitable backside or bulk micromachining technique to remove material from substrate 510 until a membrane layer of a suitable thickness is defined to span the resulting hollowed portion.

The geometry of the membrane layer and the hollowed portion spanned by the membrane layer, the geometry of the layers over the membrane layer, and the thickness, processing, and/or chemistry of materials used, for example, may influence the elastic properties of the membrane layer and may therefore influence the strain sensitivity of heater layer 530. A sensor having diaphragm structure 1700 may therefore be designed and formed as desired to help increase or decrease the strain sensitivity of heater layer 530.

Sensor with Piezoresistive Layer Separate from Heater Layer

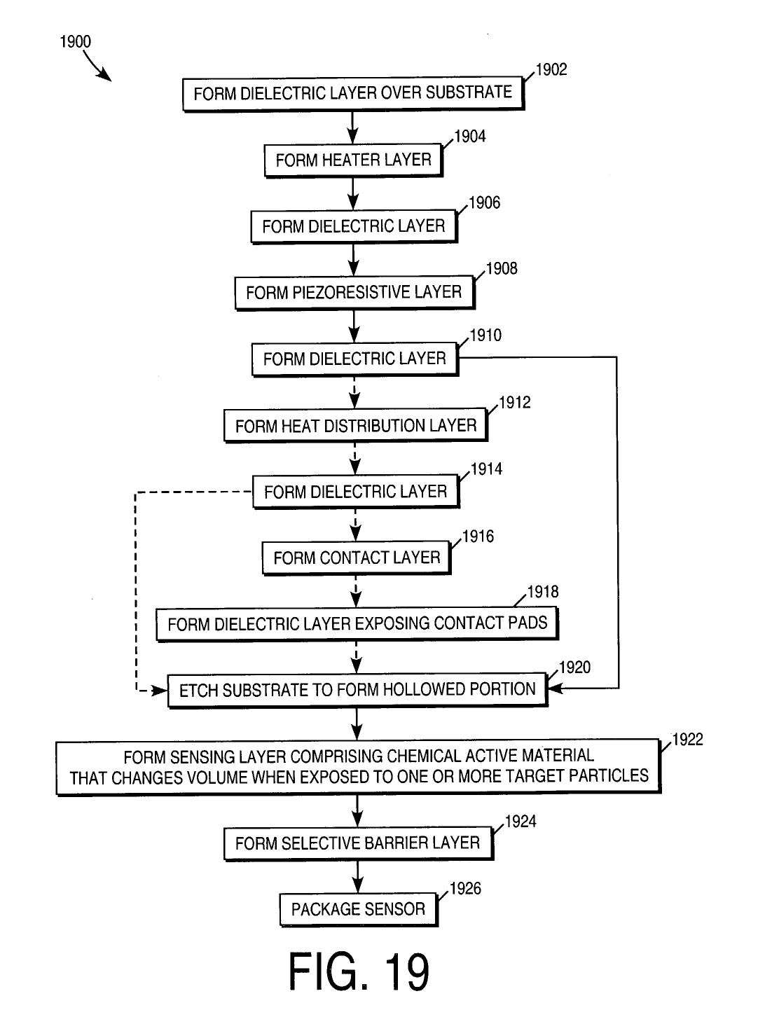

FIG. 19 illustrates a flow diagram 1900 summarizing embodiments to form for blocks 202 and 204 of FIG. 2 a piezoresistive chemical sensor having a piezoresistive layer separate from a heater layer. Blocks 1902, 1904, 1906, 1912, 1914, 1916, 1918, 1920, 1922, 1924, and 1926 of flow diagram 1900 of FIG. 19 generally correspond to blocks 402, 404, 406, 408, 410, 412, 414, 416, 418, 420, and 422, respectively, of flow diagram 400 of FIG. 4. The description of such blocks of flow diagram 400 of FIG. 4 may therefore similarly apply to corresponding blocks of flow diagram 1900 of FIG. 19 where applicable.

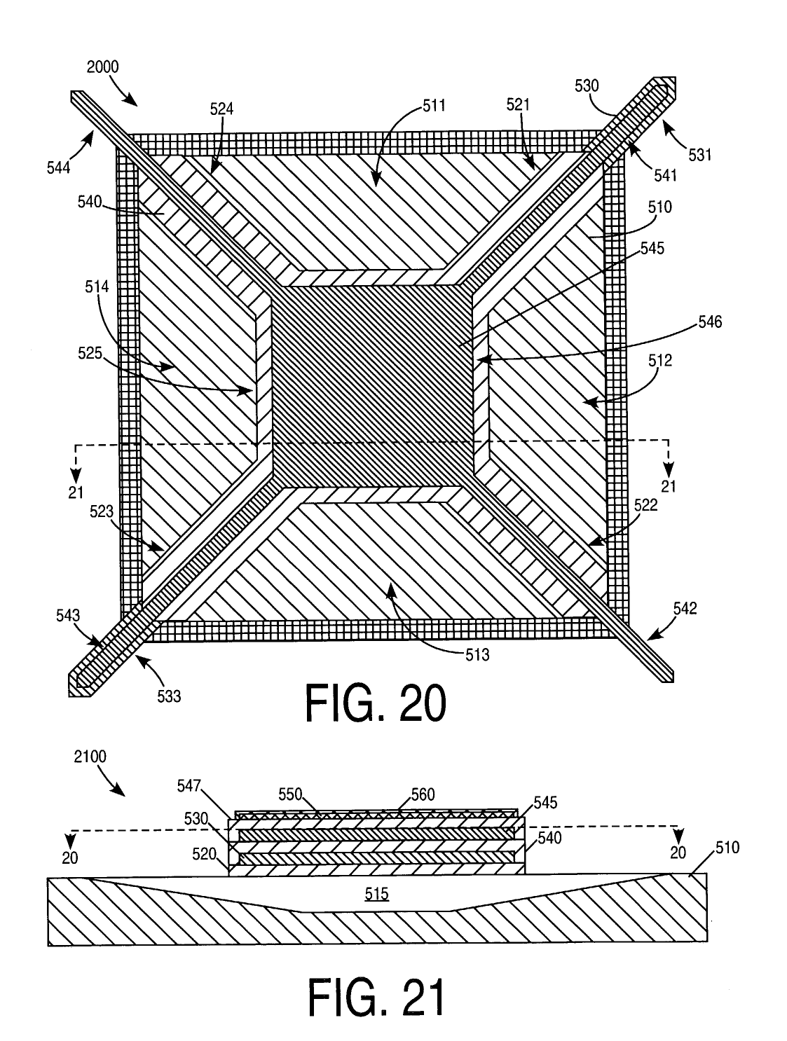

FIG. 20 illustrates, for one embodiment, a microhotplate structure 2000 that may be formed in accordance with embodiments of flow diagram 1900 of FIG. 19 to have a piezoresistive layer 545 separate from heater layer 530. FIG. 21 illustrates, for one embodiment, a piezoresistive chemical sensor 2100 formed in accordance with blocks 1902, 1904, 1906, 1908, 1910, 1920, 1922, 1924, and 1926 of flow diagram 1900 of FIG. 19 to have microhotplate structure 2000.

For block 1904 of FIG. 19, heater layer 530 may comprise any suitable material to heat one or more layers over heater layer 530. Heater layer 530 may or may not comprise a piezoresistive material for microhotplate structure 2000. Heater layer 530 may comprise, for example, polycrystalline silicon (polysilicon or poly-Si) or a doped silicon (Si). Heater layer 530 may be formed in any suitable manner to any suitable thickness over dielectric layer 520 and may be patterned in any suitable manner using any suitable technique.

After dielectric layer 540 is formed over heater layer 530 for block 1906 of FIG. 19, piezoresistive layer 545 may be formed for block 1908 over dielectric layer 540.

Piezoresistive layer 545 may comprise any suitable material and may be formed in any suitable manner to any suitable thickness over dielectric layer 540. Piezoresistive layer 545 for one embodiment may comprise polycrystalline silicon (polysilicon or poly-Si), for example, and may be deposited using, for example, a suitable chemical vapor deposition (CVD) technique and chemistry or a suitable physical vapor deposition (PVD) technique to a thickness in the range of, for example, approximately 40 nanometers (nm) to approximately 4,000 nm.

Piezoresistive layer 545 for another embodiment may comprise, for example, a single crystal silicon (Si) heavily doped with a suitable material, such as boron (B) or a suitable Group V element for example. Group V elements include phosphorous (P), and arsenic (As), for example. For one embodiment where microhotplate structure 2000 may be formed using one or more non-MOS processing techniques, piezoresistive layer 545 may comprise, for example, lead zirconium titanate ((Pb,Zr)TiO₃), chromium nitride (CrN), or barium titanate (BaTiO₃).

Piezoresistive layer 545 may be patterned in any suitable manner using any suitable technique. Piezoresistive layer 545 for one embodiment may be patterned using, for example, suitable photolithography and etch techniques. For one embodiment, as illustrated in FIG. 20, piezoresistive layer 545 may be patterned to define a substantially uniform portion 546 of a suitable shape over platform 525.

Piezoresistive layer 545 for one embodiment may also be patterned to define a suitable number of electrical leads. Piezoresistive layer 545 for one embodiment, as illustrated in FIG. 20, may be patterned to define leads 541, 542, 543, and 544 extending from portion 546 over support legs 521, 522, 523, and 524, respectively. Any suitable pair of leads 541, 542, 543, and 544 may be used to induce current flow through piezoresistive layer 545. Any suitable pair of leads 541, 542, 543, and 544 may be used to sense electrical resistance of piezoresistive layer 545. Piezoresistive layer 545 for another embodiment may be patterned to define only two, three, or more leads. For another embodiment, piezoresistive layer 545 may be conductively coupled to a suitable number of leads under piezoresistive layer 545 and/or over piezoresistive layer 545. For one embodiment, piezoresistive layer 545 may have one or more leads conductively coupled to one or more leads for one or more other layers, such as heater layer 530 for example, to help define one or more common leads, such as a ground lead for example, for multiple layers and therefore to help reduce the number of leads for sensor 2100.

Piezoresistive layer 545 for one embodiment may also be patterned to expose portions 511, 512, 513, and 514 of substrate 510 to allow hollowed portion 515 to be later etched in substrate 510.

For block 1910 of FIG. 19, a layer 547 comprising a dielectric material is formed over piezoresistive layer 545. Dielectric layer 547 for one embodiment may help electrically insulate piezoresistive layer 545 from one or more layers over piezoresistive layer 545. The description pertaining to the formation and patterning of dielectric layer 540 for block 406 of FIG. 4 similarly applies to the formation and patterning of dielectric layer 547 for block 1910 of FIG. 19.

Operations for blocks 1902, 1904, 1906, 1908, 1910, 1912, 1914, 1916, 1918, 1920, 1922, 1924, and 1926 of FIG. 19 may be performed in any suitable order and may or may not be performed so as to overlap in time the performance of any suitable operation with any other suitable operation. As one example, piezoresistive layer 545 may be formed for block 1908 over dielectric layer 520, dielectric layer 547 may be formed for block 1910 over piezoresistive layer 545, heater layer 530 may be formed for block 1904 over dielectric layer 547, and dielectric layer 540 may be formed for block 1906 over heater layer 530. As another example, heater layer 530 and piezoresistive layer 545 may both be formed over dielectric layer 520 for blocks 1904 and 1908. Dielectric layer 540 for one embodiment may then not be formed for block 1906.

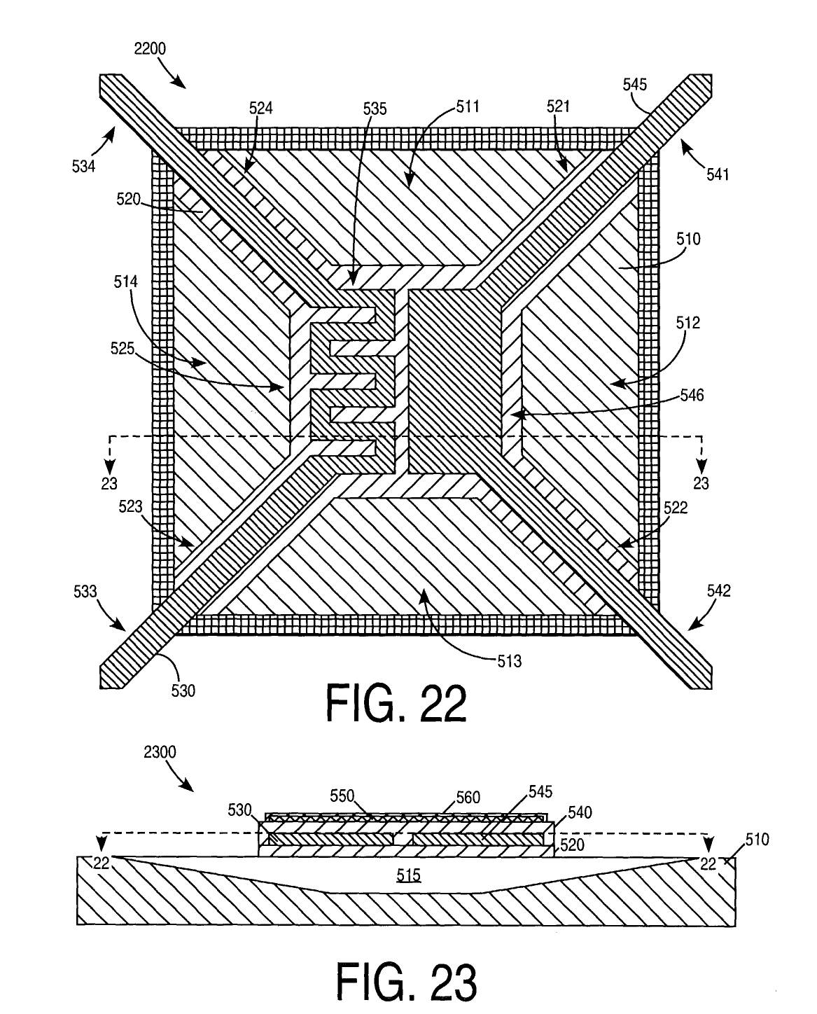

FIG. 22 illustrates, for one embodiment, a microhotplate structure 2200 that may be formed in accordance with embodiments of flow diagram 1900 of FIG. 19 to have piezoresistive layer 545 and heater layer 530 positioned in a side-by-side relationship. FIG. 23 illustrates, for one embodiment, a piezoresistive chemical sensor 2300 formed in accordance with blocks 1902, 1904, 1906, 1908, 1910, 1920, 1922, 1924, and 1926 of flow diagram 1900 of FIG. 19 to have microhotplate structure 2200.

For blocks 1904 and 1908, heater layer 530 and piezoresistive layer 545 are both formed over dielectric layer 520. Heater layer 530 and piezoresistive layer 545 for one embodiment may each comprise the same material, such as polysilicon for example, and may each be formed and patterned as the other layer is formed and patterned to produce heater layer 530 and piezoresistive layer 545 in a suitable side-by-side relationship over platform 525. For one embodiment, heater layer 530 and piezoresistive layer 545 may be defined to have a common lead, such as a ground lead for example, for both heater layer 530 and piezoresistive layer 545, helping to reduce the number of leads for sensor 2300.

The geometry of piezoresistive layer 545 and dielectric layer 547 and the thickness, processing, and/or chemistry of materials used, for example, may influence the elastic properties of supported platform 525 and may therefore influence the strain sensitivity of piezoresistive layer 545. Sensors 2100 and 2300 may therefore be designed and formed as desired to help increase or decrease the strain sensitivity of piezoresistive layer 545.

Although described in connection with a microhotplate structure, microcantilever structures and diaphragm structures may be similarly formed with piezoresistive layer 545 separate from heater layer 530.

For other embodiments, a piezoresistive chemical sensor may be formed to have a piezoresistive layer without a heater layer. Such a piezoresistive chemical sensor may be formed in accordance with embodiments of FIG. 19 without performing operations for blocks 1904 and 1906.

Use of Sensor with Piezoresistive Layer Separate from Heater Layer

Sensors 2100 and 2300 may each be used with any suitable circuitry and/or equipment in any suitable manner to sense the presence of a target particle in an environment near sensor 2100 and 2300, respectively.

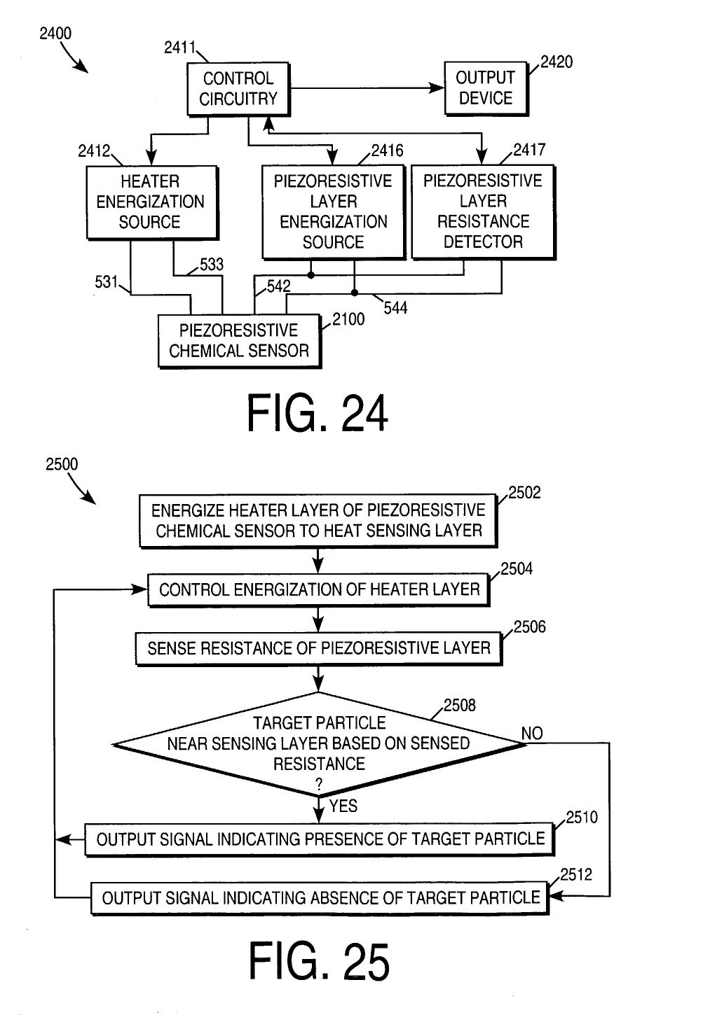

FIG. 24 illustrates, for one embodiment, a sensing device 2400 comprising sensor 2100, control circuitry 2411, a heater energization source 2412, a piezoresistive layer energization source 2416, and a piezoresistive layer resistance detector 2417. Although described in connection with sensor 2100, sensing device 2400 for another embodiment may comprise sensor 2300. Control circuitry 2411, heater energization source 2412, piezoresistive layer energization source 2416, and piezoresistive layer resistance detector 2417 collectively correspond to controller 110 of sensing device 100 of FIG. 1.

Control circuitry 2411 is coupled to heater energization source 2412, to piezoresistive layer energization source 2416, and to piezoresistive layer resistance detector 2417. Control circuitry 2411 for one embodiment may also be coupled to or in wireless communication with an output device 2420. Output device 2420 may or may not be a component of sensing device 2400. Output device 2420 corresponds to output device 120 for sensing device 100 of FIG. 1.

Control circuitry 2411 and heater energization source 2412 generally correspond to control circuitry 811 and heater energization source 812, respectively, of sensing device 800 of FIG. 8. The description of sensing device 800 of FIG. 8 may therefore similarly apply to sensing device 2400 of FIG. 24 where applicable.

Piezoresistive layer energization source 2416 and piezoresistive layer resistance detector 2417 are each coupled to piezoresistive layer 545 of sensor 2100. Piezoresistive layer energization source 2416 may be coupled to any suitable pair of leads for piezoresistive layer 545, and piezoresistive layer resistance detector 2417 may be coupled to any suitable pair of leads for piezoresistive layer 545. Piezoresistive layer energization source 2416 and piezoresistive layer resistance detector 2417 for one embodiment, as illustrated in FIG. 24, may each be coupled to leads 542 and 544 of piezoresistive layer 545.

Control circuitry 2411 may control heater energization source 2412, piezoresistive layer energization source 2416, and piezoresistive layer resistance detector 2417 to sense the presence of a target particle in an environment near sensor 2100 in any suitable manner. Control circuitry 2411 for one embodiment may control heater energization source 2412, piezoresistive layer energization source 2416, and piezoresistive layer resistance detector 2417 to sense the presence of a target particle in an environment near sensor 2100 in accordance with a flow diagram 2500 of FIG. 25.

Blocks 2502, 2504, 2506, 2508, 2510, and 2512 of flow diagram 2500 of FIG. 25 generally correspond to blocks 902, 904, 906, 908, 910, and 912, respectively, of flow diagram 900 of FIG. 9, only electrical resistance of piezoresistive layer 545 is sensed for block 2506 rather than that of heater layer 530 for block 906. The description of flow diagram 900 of FIG. 9 may therefore similarly apply to flow diagram 2500 of FIG. 25 where applicable.

For block 2506, control circuitry 2411 controls piezoresistive layer energization source 2416 to energize piezoresistive layer 545 of sensor 2100 and controls piezoresistive layer resistance detector 2417 to sense electrical resistance of piezoresistive layer 545. Piezoresistive layer energization source 2416 may comprise any suitable circuitry to energize piezoresistive layer 545 in any suitable manner, and piezoresistive layer resistance detector 2417 may comprise any suitable circuitry to sense resistance of piezoresistive layer 545 in any suitable manner.

Although illustrated as physically separate components, heater energization source 2412 and piezoresistive layer energization source 2416 for one embodiment may comprise common circuitry to energize heater layer 530 and piezoresistive layer 545, respectively, under control of control circuitry 2411.

Array of Chemical Sensors

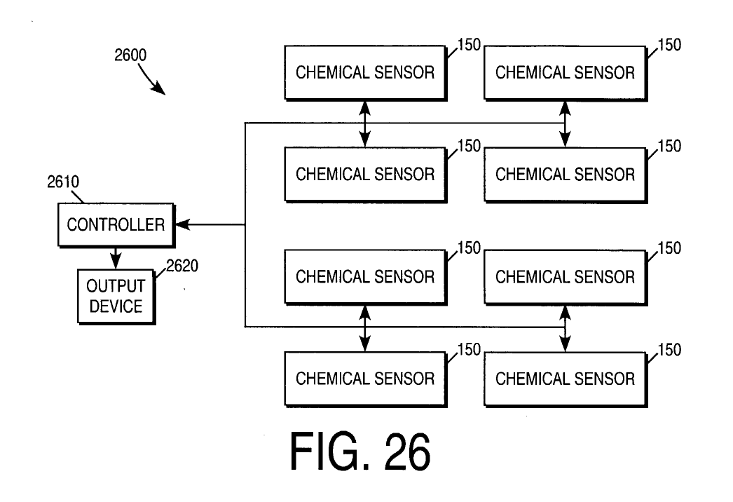

FIG. 26 illustrates, for one embodiment, a sensing device 2600 comprising a controller 2610 and a plurality of chemical sensors 150 of FIG. 1. Controller 2610 is coupled to each sensor 150 to sense the presence of a target particle in an environment near that sensor 150. Each sensor 150 is responsive to change in volume of a sensing material when exposed to one or more target particles. Each sensor 150 may be local to or remote from any other sensor 150 and/or controller 2610. Controller 2610 for one embodiment may also be coupled to or in wireless communication with an output device 2620. Output device 2620 may or may not be a component of sensing device 2600. Output device 2620 corresponds to output device 120 for sensing device 100 of FIG. 1.

Each sensor 150 may or may not be similarly formed as any other sensor 150. As one example, one sensor 150 may have a microhotplate structure while another sensor may have a microcantilever structure. As another example, one sensor 150 may have one sensing material to identify one target particle while another sensor may have another sensing material to sense another target particle.

Sensing device 2600 for one embodiment may comprise two or more similarly formed sensors 150 for purposes of redundancy. Sensing device 2600 for one embodiment may comprise two or more similarly formed sensors 150 to sense the same target particle with the same sensing material at different temperatures. Sensing device 2600 for one embodiment may comprise two or more differently formed sensors 150 to sense different target particles or to sense the same target particle with different sensing materials.

Although described as comprising a plurality of sensors 150 responsive to change in volume of a sensing material when exposed to one or more target particles, sensing device 2600 for another embodiment may comprise at least one sensor 150 responsive to change in volume of a sensing material when exposed to one or more target particles and at least one other type of sensor that senses one or more target particles in another suitable manner.

In the foregoing description, one or more embodiments of the present invention have been described. It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A sensor comprising:
sensing material that changes volume when exposed to one or more target particles; and
a transducing platform comprising a piezoresistive component to sense change in volume of the sensing material, wherein the sensing material is positioned over the piezoresistive component.

2. The sensor of claim 1, wherein the transducing platform comprises one of a microhotplate structure, a microcantilever structure, and a diaphragm structure.

3. The sensor of claim 1, wherein the transducing platform comprises a heater component to heat the sensing material.

4. The sensor of claim 1, in combination with a controller coupled to the transducing platform to sense a relative volume of the sensing material to identify whether a target particle is near the sensing material.

5. The sensor of claim 1, wherein a target particle is hydrogen.

6. A sensor comprising:
a first layer comprising a piezoresistive material to sense change in volume of one or more layers over the first layer; and
a second layer over the first layer, the second layer comprising material that changes volume when exposed to one or more target particles.

7. The sensor of claim 6, wherein the piezoresistive material of the first layer is to heat the second layer when current is induced to flow through the piezoresistive material.

8. The sensor of claim 7, comprising a heat distribution layer.

9. The sensor of claim 6, comprising a third layer to heat the second layer when current is induced to flow through the third layer.

10. The sensor of claim 9, comprising a heat distribution layer.

11. The sensor of claim 6, comprising a contact layer conductively coupled to the second layer.

12. The sensor of claim 6, comprising a platform to support the first and second layers over a hollowed portion of a substrate.

13. The sensor of claim 12, wherein the platform is deflectable.

14. The sensor of claim 6, comprising a membrane layer to support the first and second layers over a hollowed portion of a substrate.

15. The sensor of claim 6, wherein the first layer has two electrical leads and wherein the sensor has only the two electrical leads defined by the first layer.

16. The sensor of claim 6, wherein the first layer comprises one of polycrystalline silicon, barium titanate (BaTiO₃), silicon (Si), lead zirconium titanate ((Pb,Zr)TiO₃), and chromium nitride (CrN).

17. The sensor of claim 6, wherein the second layer comprises at least one of a rare earth element, a Group II element, lithium (Li), a Group VB element, palladium (Pd), titanium (Ti), zirconium (Zr), and a polymer.

18. The sensor of claim 6, wherein the first layer comprises polycrystalline silicon and the second layer comprises yttrium (Y).

19. The sensor of claim 6, wherein a target particle is hydrogen.

20. An apparatus comprising:
sensing material that changes volume when exposed to one or more target particles;
means for sensing change in volume of the sensing material; and
means for controlling temperature of the sensing material.

21. A sensing device comprising:
a sensor comprising a piezoresistive layer and sensing material over the piezoresistive layer, wherein the sensing material changes volume when exposed to one or more target particles; and
a controller to sense a resistance of the piezoresistive layer.

22. The sensing device of claim 21, wherein the controller comprises:
a source to energize the piezoresistive layer to heat the sensing material;
a detector to sense a resistance of the piezoresistive layer; and
control circuitry to control the source and to identify a presence of a target particle near the sensing material based on the sensed resistance of the piezoresistive layer.

23. The sensing device of claim 22, wherein the controller comprises another source to energize the sensing material.

24. The sensing device of claim 23, wherein the controller comprises another detector to sense a resistance of the sensing material; and
wherein the control circuitry is to identify a presence of a target particle near the sensing material based on the sensed resistance of the piezoresistive layer and/or based on the sensed resistance of the sensing material.

25. The sensing device of claim 21, wherein the sensor comprises a heater layer and wherein the controller comprises:
a first source to energize the heater layer to heat the sensing material;
a second source to energize the piezoresistive layer;
a detector to sense a resistance of the piezoresistive layer; and
control circuitry to control the first source and to identify a presence of a target particle near the sensing material based on the sensed resistance of the piezoresistive layer.

26. The sensing device of claim 25, wherein the controller comprises a third source to energize the sensing material.

27. The sensing device of claim 26, wherein the controller comprises another detector to sense a resistance of the sensing material; and
wherein the control circuitry is to identify a presence of a target particle near the sensing material based on the sensed resistance of the piezoresistive layer and/or based on the sensed resistance of the sensing material.

28. The sensing device of claim 21, wherein the piezoresistive layer comprises one of polycrystalline silicon, barium titanate (BaTiO₃), silicon (Si), lead zirconium titanate ((Pb,Zr)TiO₃), and chromium nitride (CrN).

29. The sensing device of claim 21, wherein the sensing material comprises at least one of a rare earth element, a Group II element, lithium (Li), a Group VB element, palladium (Pd), titanium (Ti), zirconium (Zr), and a polymer.

30. The sensing device of claim 21, wherein the piezoresistive layer comprises polycrystalline silicon and the sensing material comprises yttrium (Y).

31. The sensing device of claim 21, wherein a target particle is hydrogen.

32. A method comprising:
forming over a substrate a first layer comprising a piezoresistive material to sense change in volume of one or more layers over the first layer; and
forming over the first layer a second layer comprising a material that changes volume when exposed to a target particle.

33. The method of claim 32, wherein the forming the first layer comprises forming the first layer to comprise one of polycrystalline silicon, barium titanate (BaTiO₃), silicon (Si), lead zirconium titanate ((Pb,Zr)TiO₃), and chromium nitride (CrN).

34. The method of claim 32, wherein the forming the second layer comprises forming the second layer to comprise at least one of a rare earth element, a Group II element, lithium (Li), a Group VB element, palladium (Pd), titanium (Ti), zirconium (Zr), and a polymer.

35. The method of claim 32, wherein the forming the first layer comprises forming the first layer to comprise polycrystalline silicon; and
wherein the forming the second layer comprises forming the second layer to comprise yttrium (Y).

36. The method of claim 32, wherein the forming the first layer comprises forming the piezoresistive material to heat the second layer when current is induced to flow through the piezoresistive material.

37. The method of claim 36, comprising forming a heat distribution layer.

38. The method of claim 32, comprising forming a third layer to heat the second layer when current is induced to flow through the third layer.

39. The method of claim 38, comprising forming a heat distribution layer.

40. The method of claim 32, comprising forming a contact layer for conductive coupling to the second layer.

41. The method of claim 32, comprising defining a platform to support the first and second layers over a hollowed portion of a substrate.

42. The method of claim 41, wherein the defining the platform comprises defining the platform to be deflectable.

43. The method of claim 32, comprising forming a membrane layer spanning a hollowed portion of a substrate to support the first and second layers over the hollowed portion.

44. The method of claim 32, wherein a target particle is hydrogen.

45. A method comprising:
sensing a resistance of a piezoresistive layer with sensing material over the piezoresistive layer, wherein the sensing material changes volume when exposed to one or more target particles; and
identifying whether a target particle is near the sensing material based on the sensed resistance of the piezoresistive layer.

46. The method of claim 45, comprising:
energizing the piezoresistive layer to heat the sensing material.

47. The method of claim 45, comprising:
energizing the sensing material.

48. The method of claim 45, comprising sensing a resistance of the sensing material;
wherein the identifying comprises identifying whether a target particle is near the sensing material based on the sensed resistance of the piezoresistive layer and/or based on the sensed resistance of the sensing material.

49. The method of claim 45, comprising:
energizing a heater layer to heat the sensing material.

50. A sensing device comprising:
an array of sensors, wherein at least one sensor comprises a piezoresistive layer and sensing material over the piezoresistive layer and wherein the sensing material changes volume when exposed to one or more target particles; and
a controller coupled to the array of sensors to sense a resistance of the piezoresistive layer of at least one sensor.
